(19) United States
(12) Patent Application Publication
(10) Pub. No.: US 2025/0307773 A1
(43) Pub. Date: Oct. 2, 2025

(54) AUTOMATION RULE BUILDER FOR COLLABORATION PLATFORMS

(71) Applicant: Atlassian Pty Ltd., Sydney (AU)

(72) Inventors: Trevor Angle, Austin, TX (US); Kai Chen, Mountain View, CA (US); Anand Kashyap, San Jose, CA (US); Dan Cristian Rotaru, Perth (AU)

(21) Appl. No.: 18/616,471

(22) Filed: Mar. 26, 2024

(51) Int. Cl. G06Q 10/10

(52) U.S. Cl. CPC G06Q 10/103

(57) ABSTRACT

Embodiments described herein relate to systems and methods for automation rule creation for collaboration platforms. A graphical user interface (GUI) with an automation rule input field may be generated. A trigger component and an action component may be selected for an automation rule. A system including the collaboration platform then determines a set of compatible action components based on the trigger and action components. Compatible actions from the set of component actions may then be selected for the automation rule. A service can then be generated according to the automation rule, and the rule enabled if validation passes for the automation rule.

### TECHNICAL FIELD

Embodiments described herein relate to multitenant services of collaborative work environments and, in particular, to systems and methods for automation rule creation for collaboration platforms.

### BACKGROUND

An organization can establish a collaborative work environment by self-hosting, or providing its employees with access to, a suite of discrete software platforms or services to facilitate cooperation and completion of work. In many cases, the organization may also define policies outlining best practices for interacting with, and organizing data within, each software platform of the suite of software platforms.

Often internal best practice policies require employees to thoroughly document completion of tasks, assignment of work, decision points, and so on. Such policies additionally often require employees to structure and format documentation in particulars ways, to copy data or status information between multiple platforms at specific times, or to perform other rigidly defined, policy-driven, tasks. These requirements are both time and resource consuming for employees, reducing overall team and individual productivity.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system that includes a centralized automation rule service for the creation of automation rules.

FIG. 2 depicts an example frontend interface that supports automation rule creation for collaboration platforms, in accordance with aspects described herein.

FIG. 3 depicts an example frontend interface that supports automation rule creation for collaboration platforms, in accordance with aspects described herein.

FIG. 4 depicts an example frontend interface that supports automation rule creation for collaboration platforms, in accordance with aspects described herein.

FIG. 5 depicts an example frontend interface that supports automation rule creation for collaboration platforms, in accordance with aspects described herein.

FIG. 6 depicts an example frontend interface that supports automation rule creation for collaboration platforms, in accordance with aspects described herein.

FIG. 7 depicts an example frontend interface that supports automation rule creation for collaboration platforms, in accordance with aspects described herein.

FIG. 8 depicts an example frontend interface that supports automation rule creation for collaboration platforms, in accordance with aspects described herein.

FIG. 9 depicts an example frontend interface that supports automation rule creation for collaboration platforms, in accordance with aspects described herein.

FIGS. 10A-10D depict examples of a first portion, a second portion, a third portion, and a fourth portion of a frontend interface that supports automation rule creation for collaboration platforms, in accordance with aspects described herein.

FIG. 11 depicts an example of a portion of a frontend interface that supports automation rule creation for collaboration platforms, in accordance with aspects described herein.

FIG. 12 depicts an example method of automation rule creation, in accordance with aspects described herein.

FIG. 13 depicts a system diagram and network/communication architectures that may support a system as described herein.

FIG. 14 depicts a functional system diagram of network/communication architectures that may support a system as described herein.

FIG. 15 depicts a simplified system diagram and data processing pipeline.

FIG. 16 depicts a system providing multiplatform prompt management as a service.

FIG. 17 shows a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems, devices, and methods for automatically generating rules for collaboration platforms, such as documentation systems, issue tracking systems, project management platforms, and the like.

Collaboration platforms can be used to generate, store, and organize user-generated content. As described herein, a collaboration platform or service may include an editor that is configured to receive user input and generate user-generated content that is saved as a content item. The terms “collaboration platform” or “collaboration service” may be used to refer to a documentation platform or service configured to manage electronic documents or pages created by the system users, an issue tracking platform or service that is configured to manage or track issues or tickets in accordance with an issue or ticket workflow, a source-code management platform or service that is configured to manage source code and other aspects of a software product, a manufacturing resource planning platform or service configured to manage inventory, purchases, sales activity or other aspects of a company or enterprise. The examples provided herein are described with respect to an editor that is integrated with the collaboration platform. In some instances, the functionality described herein may be adapted to multiple platforms or adapted for cross-platform use through the use of a common or unitary editor service. For example, the functionality described in each example is provided with respect to a particular collaboration platform, but the same or similar functionality can be extended to other platforms by using the same editor service. Also, as described above a set of host services or platforms may be accessed through a common gateway or using a common authentication scheme, which may allow a user to transition between platforms and access platform-specific content without having to enter user credentials for each platform.

An automation rule (which may also be referred to as “automated rules,” or simply “rules”) is an automated workflow that is generally constructed in a “if this, then that” format. Typically, for example a collaboration platform, an automation rule results in the performance of an action upon the occurrence of a trigger, if certain conditions are met. In a collaboration platform, each rule automation rule is made by combining different types of components, including triggers and actions. An automation rule typically also includes a condition. Branches may also be used in some cases. As used herein, automation rules begin with a trigger (which may also be referred to as a trigger component), the trigger being the catalyst that sets the execution of a rule in motion. In one or more embodiments, a condition (which may also be referred to as a condition component) may also be used, where the condition is a limit on the scope of the automation rule. For example, a condition may require that the rule may only be run when the action that initiated the trigger was performed by a certain user or group of users. As used herein, an action (or action component) is what the rule to does or performs, for example what happens when the trigger (and conditions if applicable) is met. In some embodiments, an automation rule may also include a branch. A branch expands the performance or execution of a rule by adding a secondary path (a branch). As used herein, a branch is a sequence of conditions and/or actions that run in isolation from the rest of the rule, but are applied to each (e.g., every) instance of an object. For example, the rule for each task (e.g., an object) can be branched so that a message is sent to a recipient every time a person is mentioned on a particular page (e.g., when such page is published). This branch action occurs in addition to any action on the primary path of the automation rule chain.

In some cases, a collaboration platform may include a large amount of content to be managed. Certain tasks may require many repetitive actions or a person responsible for managing content may not realize that an action need to be performed to manage the content. As such, a collaboration platform may benefit from allowing users to establish automation rules to automatically perform such tasks that would otherwise need to be performed manually. Such automation rules can reduce management overhead, saving time and freeing up resources, and add management consistency, increasing transparency and organization, while reducing errors. However, the creation of automation rules can require multiple steps, technical acumen, knowledge of terms, connectors, and other specialized language that may not be known to a typical user of the collaboration platform.

Tools for automation rule building may be used to assist users of a system to more easily generate automation rules using little to no code. In some tools, automation rule components (e.g., elements, blocks) may be provided for a user. These components may include triggers, actions, branches, and so on that represent underlying blocks of code, and may further include fields that can be customized by the user for a specific use case. Using these components, a user can more easily (e.g., in a graphical user interface) create automation rules.

However, not all automation rule components may be compatible. An automation rule may be constructed by a user, then fail on use, because of incompatible components or portions of components (e.g., lack of required inputs or outputs). In some cases, the automation rule may run infrequently, such that the failure is detected much later, or only upon the occurrence of a relatively rare condition. Thus, discovering the failure may be delayed, making automation rule building slow and inefficient. The failure may be in a log (e.g., an audit) that the user needs to wade through, making diagnosis challenging. Moreover, determining the source of a failure may be difficult, for example for complex automation rules having many components, some of which may interact in ways that are difficult for a user to foresee or otherwise identify.

In addition, automation rules may operate across platforms of a system (e.g., a content collaboration system). Automation rules and rule components that operate successfully for one platform or context, may fail in another platform or when operating across platforms. For example, a user of one platform (e.g., a user running the automation rule) may have different permissions or no permissions in another platform. For example, the user may have limited access or editing ability, causing automation rule failure.

As such, improved techniques, devices, and processes are desired to facilitate the creation and validation of automation rules for collaboration platforms.

As further described herein, automation rule creation (building) for collaboration systems is described. In one or more embodiments, a user of a collaboration system, or a platform thereof (e.g., a user of one or more systems, programs, applications, or components of a collaboration platform), can generate an automation rule in an automation rule builder. The automation rule builder presents a graphical user interface (GUI) of the collaboration system (e.g., of one of the platforms of the collaboration system). Automation rule components, including triggers and actions, have corresponding graphical elements that are generated for the GUI, and displayed for a user. To assist the user in building (creating) a valid automation rule, as the user selects automation rule components, the collaboration system determines compatible automation rule components (e.g., compatible actions) that are based on automation rule components that have been previously-selected by the user. The collaboration system may present compatible actions or other rule components, hide incompatible actions or rule components, or otherwise indicate combinations or series of automation rule components that are compatible with other automation rule components. Among other benefits, determining compatibility during rule creation can assist a user in building a valid rule, as well as diagnosing errors and other issues during building of automation rules. Users building automation rules as described herein can therefore save time, lower expenses, reduce errors, increase engagement with collaboration systems, and otherwise perform administrative and management tasks more effectively and efficiently.

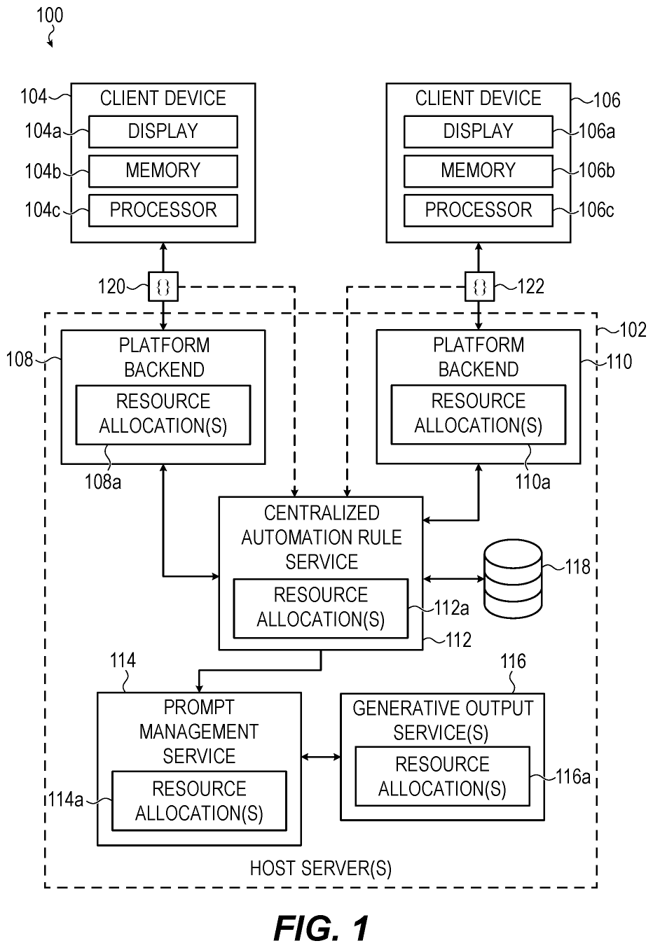

FIG. 1 depicts a simplified diagram of a system that includes a centralized automation rule service for the creation of automation rules, as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices. Two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples information technology system management (ITSM) systems, chat platforms, messaging platforms, and the like. These backends can be communicably coupled to a centralized automation rule service that can be leveraged to provide functionality to each respective backend. For example, the centralized automation rule service can be configured to receive user prompts, such as described herein, to modify, create, or otherwise perform operations to build, validate, debug, or otherwise create and manage automation rules acting on content stored by each respective software platform and triggered by events that may occurs at one or more of the software platforms. The centralized automation rule service may provide a single, unified interface to automation rules that operate across different platforms of the host servers 102, providing management and creation capabilities across different platforms of the system.

By centralizing the automation rule service in this manner, the centralized automation rule service can also serve as an integration between multiple platforms. For example, one platform may be a documentation platform and the other platform may be an issue tracking system. In these examples, a user of the documentation platform may create an automation rule that is triggered off of an event that occurs at the documentation platform. An action in response to this event may be performed on one or more objects of the issue tracking system.

A portion of the set of host servers 102 can be allocated as physical infrastructure supporting a first platform backend 108 and a different portion of the set of host servers 102 can be allocated as physical infrastructure supporting a second platform backend 110.

The two different platforms maybe instantiated over physical resources provided by the set of host servers 102. Once instantiated, the first platform backend 108 and the second platform backend 110 can each be communicably coupled with a centralized automation rule service 112 (also referred to as an “automation rule builder” or an “automation rule manager”).

The centralized automation rule service 112 can be configured to cause rendering of a GUI within respective frontends of each of the first platform backend 108 and the second platform backend 110. In this manner, and as a result of this construction, each of the first platform and the second platform present a consistent automation rule creation and management experience for a user.

The centralized automation rule service 112 may include both text input functions as well as selectable graphical elements to select and edit automation rules and components. Selected graphical elements may represent triggers and/or action across different platforms. As a result of the text input or selection of graphical elements, the centralized automation rule service 112 may present graphical elements representing the selected components that make up an automation, for example on the display 104a of a client device 104, or on the display 106a of the client device 106. As a result of this centralized architecture, multiple platforms in a multiplatform environment can leverage the features of the automation rule service. This provides a consistent experience to users while providing for cross-platform features for the automation rules.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized automation rule service 112 that can be called by each respective frontend whenever it is required to present the user of that respective frontend with an interface to create and manage automation rules.

As described herein, a “content editing frame” references a user interface element that can be leveraged by a user to draft and/or modify rich content including, but not limited to formatted text; image editing; data tabling and charting; file viewing; and so on. These examples are not exhaustive; the content editing elements can include and/or may be implemented to include many features, which may vary from embodiment to embodiment. For simplicity of description the embodiments that follow reference a centralized automation rule service 112 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized automation rule service 112 can be extended to include additional features and functionality that, in turn, can automatically be leveraged by any further platform that incorporates an automation rule builder, and/or otherwise integrates with the centralized automation rule service 112 itself.

In some examples, prompts can be provided as input to a prompt engineering/prompt preconditioning service (such as the prompt management service 114) that, in turn, provides a modified user prompt as input to a generative output service 116. The generative output service 116 may be hosted over the host servers 102 or, in other cases, may be a software instance instantiated over separate hardware. In some cases, the generative output service 116 may be a third party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on. In some cases, the generative output service 116 can be configured to provide an output as part of an action of an automation rule. The output can be in response to a prompt that includes content referenced by the automation rule, for example a summary of the content created when the automation rule is triggered and run.

Alternatively, when interacting with the same documentation system, a user having a role of “human resources professional” may be presented with prompts associated with manipulating or summarizing information presented in a directory system or a benefits system, instead of the issue tracking system or the code repository system.

More generally, in some embodiments described herein, a centralized automation rule service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized automation rule service 112 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More specifically, the first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified as the resources 104a-104c of the client devices, respectively.

As with many embodiments described herein, the first platform frontend can be configured to communicate with the first platform backend 108 and/or the centralized automation rule service 112. Information can be transacted by and between the frontend, the first platform backend 108 and the centralized automation rule service 112 in any suitable manner or form or format. In many embodiments, as noted above, the client device 104 and in particular the first platform frontend can be configured to send an authentication token 120 along with each request transmitted to any of the first platform backend 108 or the centralized automation rule service 112 or the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified as the client devices resources 106a-106c, respectively.

As with many embodiments described herein, the second platform frontend can be configured to communicate with the second platform backend 110 and/or the centralized automation rule service 112. Information can be transacted by and between the frontend, the second platform backend 110 and the centralized automation rule service 112 in any suitable manner or form or format. In many embodiments, as noted above, the client device 106 and in particular the second platform frontend can be configured to send an authentication token 122 along with each request transmitted to any of the second platform backend 110 or the centralized automation rule service 112.

As a result of these constructions, the centralized automation rule service 112 can provide uniform feature sets to users of either the client device 104 or the client device 106. For example, the centralized automation rule service 112 can implement an automation rule processor to receive an automation rule input provided by a user of the client device 104 to the first platform and/or to receive an automation rule input provided by a different user of the client device 106 to the second platform. Created automation rules may then be accessible to each user via the different ones of client device 104 and client device 106 for management, editing, and so on.

As noted above, the centralized automation rule service 112 ensures that common features are available to frontends of different platforms. One such class of features provided by the centralized automation rule service 112 invokes output of a generative output engine of a service such as the generative output service 116. For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system (not depicted with reference to system 100). For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

The prompt management service 114 can be configured to receive user input (provided via a graphical user interface of the client device 104 or the client device 106) from the centralized automation rule service 112. The prompt management service 114 can also be configured to receive an automation rule input from the centralized automation rule service 112 in connection with running of an automation rule. The user input or automation rule input may include a prompt to be continued by the generative output service 116. The prompt management service 114 can be configured to modify the user input or automation rule input, to supplement the input, select a prompt from a database (e.g., the database 118) based on the input, insert the input into a template prompt, replace words within the input, preform searches of databases (such as user graphs, team graphs, and so on) of either the first platform backend 108 or the second platform backend 110, change grammar or spelling of the input, change a language of the input, and so on. The prompt management service 114 may also be referred to herein as herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized automation rule service 112 to return to a suitable backend application, to in turn return to or perform a task for the benefit of a client device such as the client device 104 or the client device 106. More particularly, it may be appreciate that although system 100 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized automation rule service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, some embodiments described herein, and with particular reference to system 100, relate to systems for running automation rules. Those automation rules may collect one or more portions of content of the system 100, modify that user input into a particular engineered prompt, and submitting that prompt as input to a trained large language model. Output of the LLM can be used in a number of suitable ways.

These foregoing embodiments depicted with reference to system 100 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized automation rule service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organizations datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to KanbanBoard456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to KanbanBoard456, and whether the requesting user has read access to the referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized automation rule service.

As further described herein, the system 100 supports automation rule creation. In one or more embodiments, a GUI is displayed at a client device that includes an input field. In some cases, the client device 104, associated with the first platform backend 108, provides an interface with a first type of software platform, and the client device 106, associated with the second platform backend 110, provides an interface with a different type of software platform. Either or both of client device 104 or client device 106 may generate a GUI allowing user input for automation rule generation. As further described herein, the host servers 102 can utilize the services of a generative output service 116 to programmatically generate automation rules or portion of automation rules from inputs, including one or more natural language inputs or selections of graphical elements. In some examples, the generative output service 116 can be used to provide indications (e.g., suggestions, recommendations) for automation rule components for selection by a user as part of automation rule building and creation.

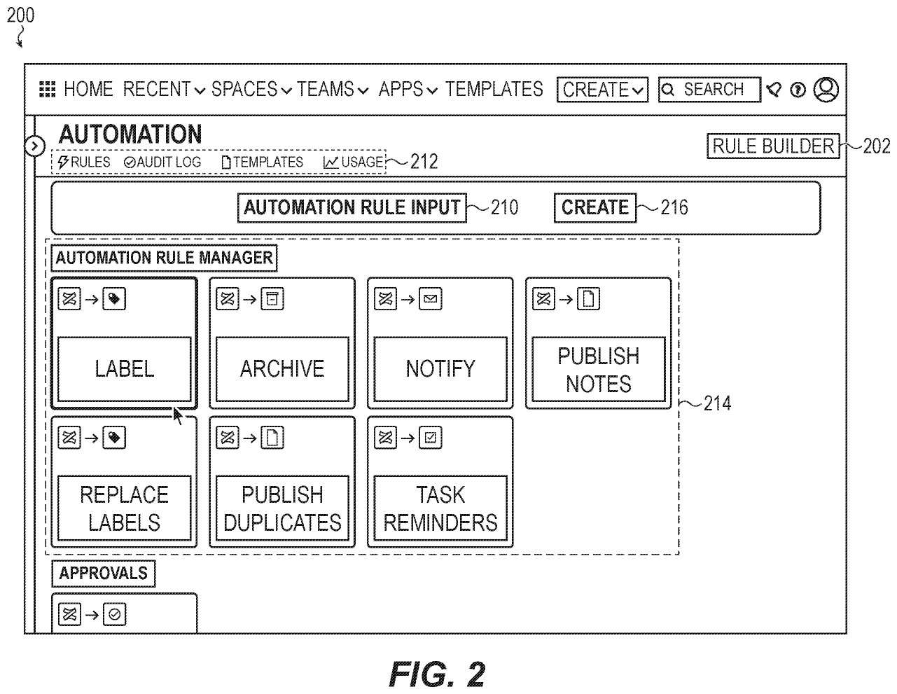

FIG. 2 depicts an example frontend interface 200 that supports automation rule creation for collaboration platforms, in accordance with aspects described herein. Frontend interface 200 may also be referred to as a UI or GUI. The frontend interface 200 can be rendered by a client device 104 or a client device 106, which may be a personal electronic device such as a laptop, desktop computer, tablet and the like. The client device can include a display with an active display area in which a user interface, e.g., frontend interface 200 can be rendered. The user interface can be rendered by operation of an instance of a frontend application associated with a backend application that collectively define a software platform as described herein.

More particularly, as described with reference to system 100, a platform can be defined by communicably intercoupling one or more frontend instances with one or more backend instances. The backend instance of software can be instantiated over server hardware such as a processor, memory, storage, and network communications. The frontend application can be instantiated over physical hardware of a client device in network communication with the backend application instance. The frontend application can be a native application, a browser application, or other application type instantiated over hardware directly or indirectly, such as within an operating system environment.

As shown, frontend interface 200 includes rule builder button 202, a text input field 210, selectable tabs 212, a display area 214, and a create button 216. Text input field 210 is field configured to accept textual inputs, for example a natural language rule for the creation of automation rules. The create button 216 can be used to submit the textual input in the text input field 210 for creation of an automation rule by the system 100, for example using or aided by a generative output service.

In one or more embodiments, selectable tabs 212 include tabs for “rules,” “an audit log,” “templates,” and “usage,” each of which may cause a different display to appear in display area 214. Selecting the rules field causes the display area 214 to display automation rules for management. The information for the displayed rule can include at least a name, description scope (e.g., on what projects, or types of projects, the rule will run), an indication of whether to allow the rule to run from another rule, an error notification status, an owner of the rule, a rule actor (e.g., the party indicated as responsible when the rule is executed), and permissions for the rule (e.g., persons or groups allowed to modify the rule). As an example of automation rules, an automation rule manager may display a list, icon, or other indicator of automation rules created by a user in display area 214. Examples of such automation rules (e.g., created or for a template, as further discussed herein) include a “label” rule (e.g., adding a specific label when a page is published by a certain author), an “archive” rule (e.g., archiving inactive pages when scheduled (recurring)), a “notify” rule (e.g., notify certain people about inactive pages when scheduled (recurring)), a “publish notes” rule (e.g., publish new meeting notes page when scheduled (recurring)), a “replace labels” rule (e.g., replace a label on all pages when scheduled (recurring)), a “publish duplicates” rule (e.g., publish the same set of pages when a new space is created), and a “task reminders” rule (e.g., remind teammates about incomplete tasks when scheduled (recurring)). In some embodiments, these example rules may support automation rules within a documentation platform. In other embodiments such rules, or other rules, can be for other platforms or a combination of platforms within a system including collaboration platforms.

In one or more embodiments, selecting the templates tab may cause a display to appear in display area 214 that includes templates that a user may utilize to create automation rules from a template. Such templates provide predefined structure for common automation rules that a user may want to use in the manual creation of an automation rule.

In one or more embodiments, selecting the audit log tab may cause a display to appear in display area 214 that includes an audit log for the automation rules. In one or more embodiments, each automation rule may include an audit log that identifies when the automation rule was triggered, the final result of the execution of the automation rule, and any action performed as a result of the automation rule execution. In some embodiments, the audit log may indicate a duration of the execution and the status (e.g., success, error, and so on) of the execution.

In one or more embodiments, selecting the usage tab may cause a display to appear in display area 214 that includes usage information for the automation rules. The usage information includes an outline of your automation usage (e.g., for a particular time frame). For example, each automation rule may be identified, together with a quantity of runs/executions of the automation rule, an “owner” or other responsible person for the rule, a scope of the rule (e.g., which collaboration systems are associated with the rule), and an activation status for the automation rule (e.g., whether execution of the rule is turned “on” or “off”).

According to one or more embodiments, previously-created automation rules, including automation rules generate from using a generative output engine, as further described herein, can be stored at the system 100. In some examples, rules may be stored in a database 118 for retrieval and use by a component of the set of host servers 102, such as the centralized automation rule service 112, the first platform backend 108, or the second platform backend 110. In some examples, the rules may be stored in the resource allocation of a portion of the host servers 102, such as the resource allocation of the platform from which the automation rule is to be executed, for example resource allocations 108a of the first platform backend 108, or resource allocations 110a of the second platform backend 110.

In one or more embodiments, the rule builder button 202 may be selected by a user to direct the frontend interface 200 to a rule builder that can be leveraged by a user to generate automation rules from components with assistance from graphical elements, as further described herein.

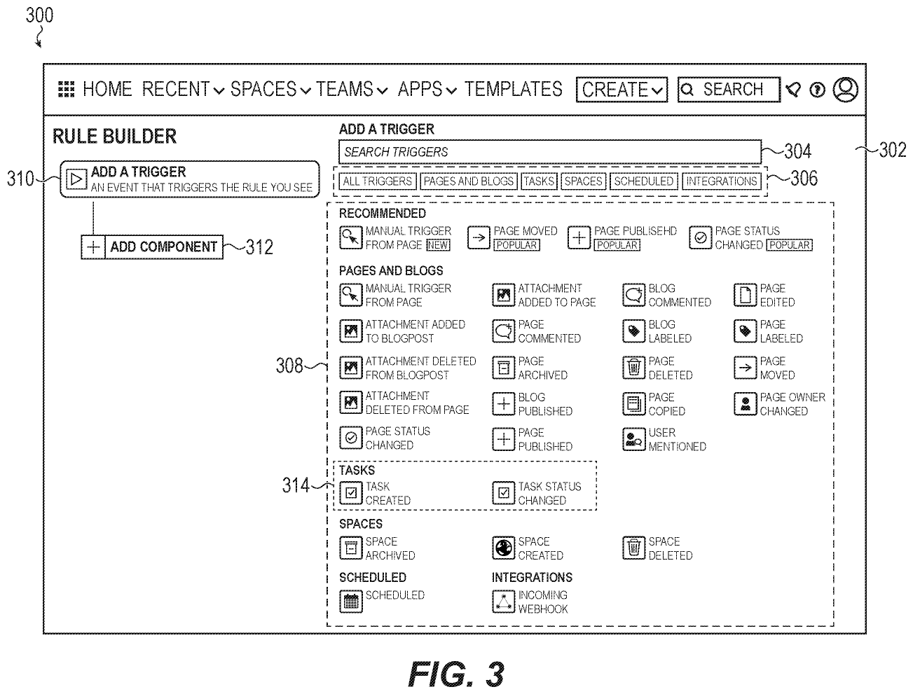

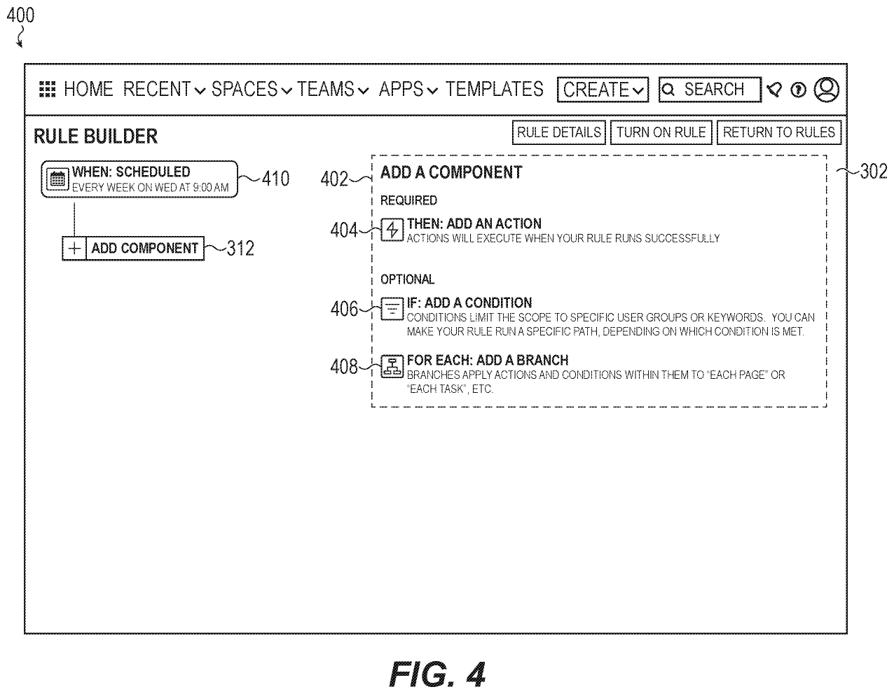

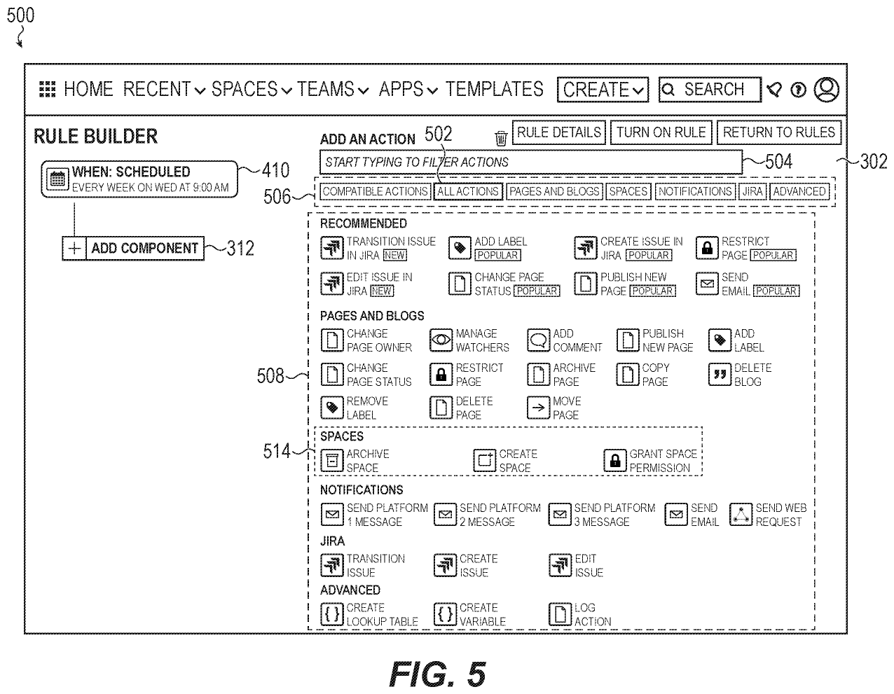

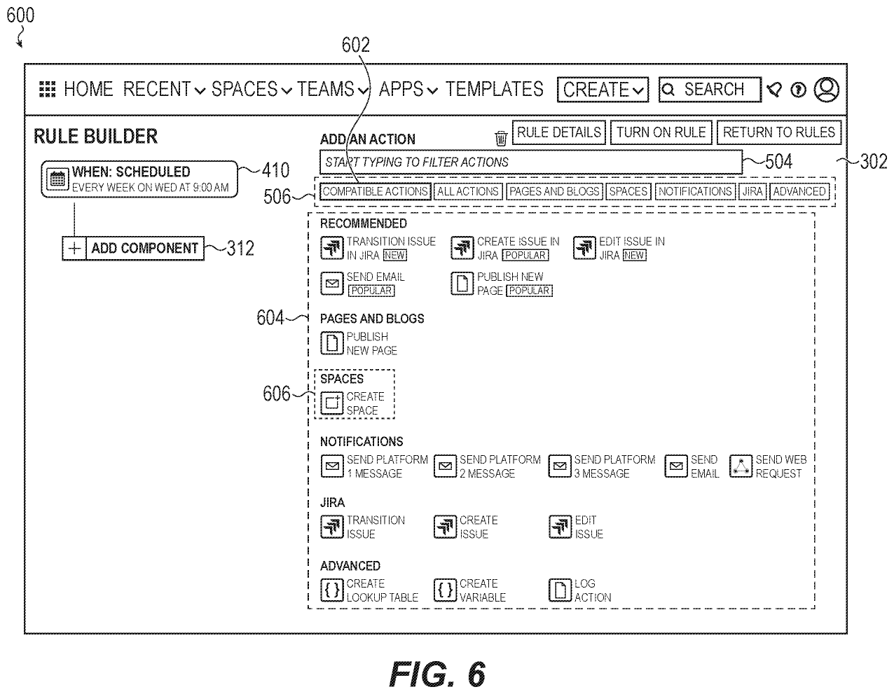

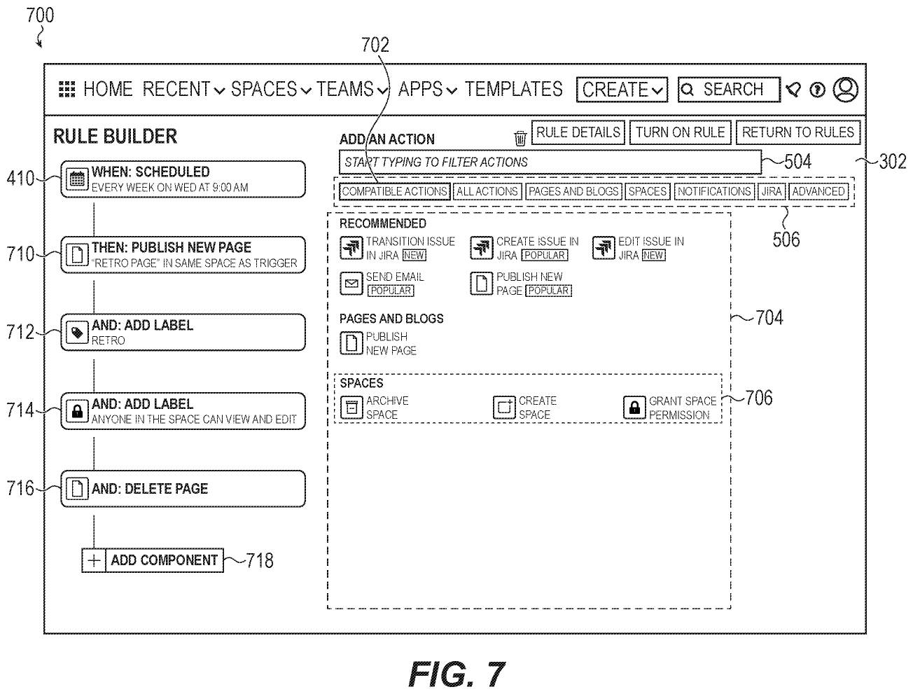

FIGS. 3-7 generally depict frontend interfaces in an example of a flow to generate an automation rule. FIG. 3 generally depicts the selection of a trigger component for an automation rule flow. FIG. 4 generally depicts required and optional component categories for a user to select to display additional automation rule components to add to the automation rule flow, incorporating the previously-selected trigger component. FIG. 5 generally depicts the selection of an action component for an automation rule flow, incorporating the previously-selected trigger component, where all action components are displayed. FIG. 6 generally depicts the selection of an action component for an automation rule flow, where only compatible action components are displayed. FIG. 7 generally depicts the selection of an action component for an automation rule flow, where only compatible action components are displayed, and a number of action components have already been added to the automation rule flow (e.g., narrowing or limiting the number and/or type of compatible action components).

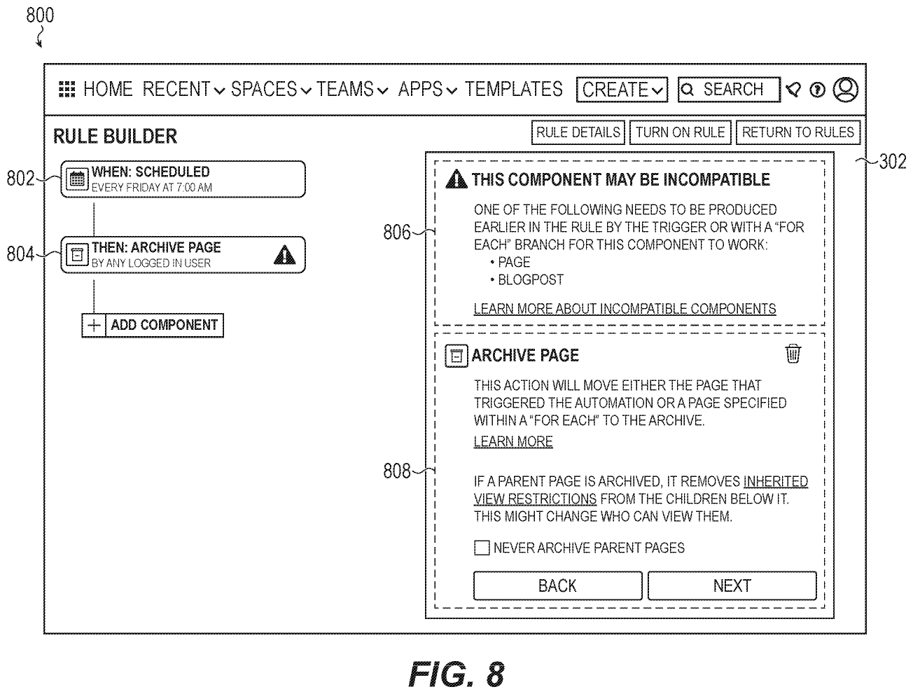

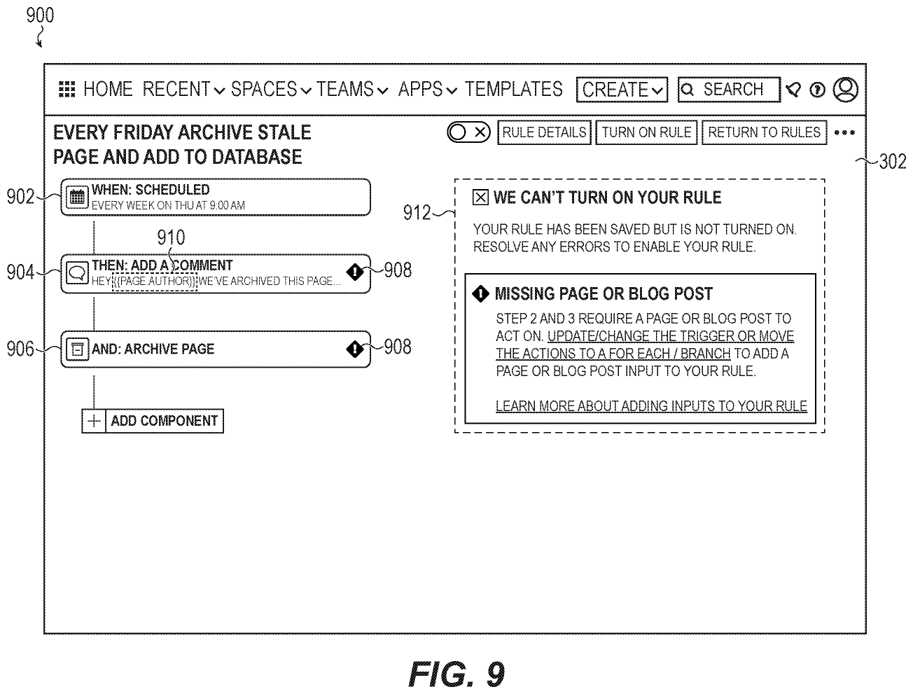

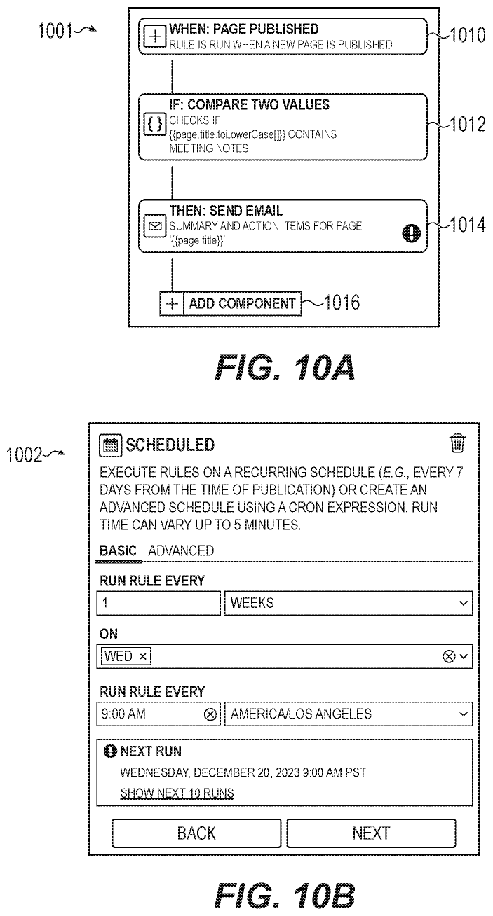

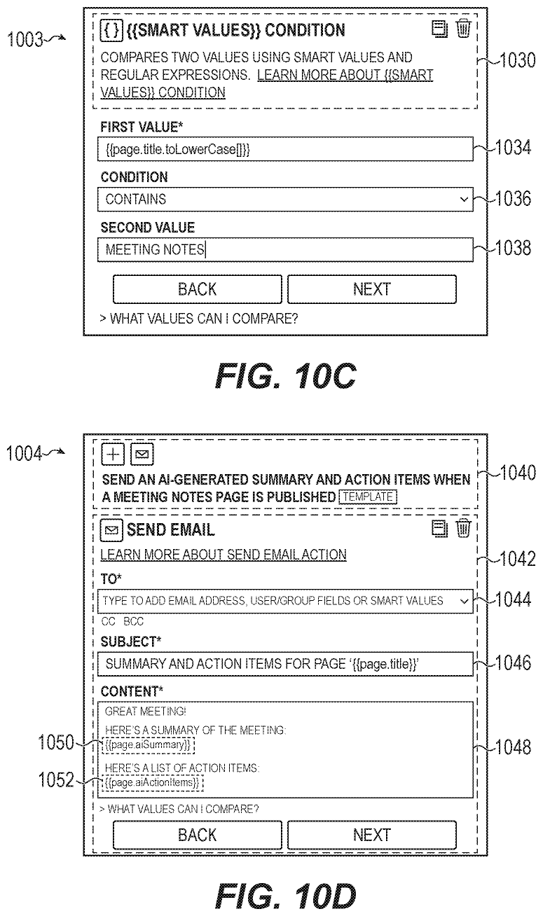

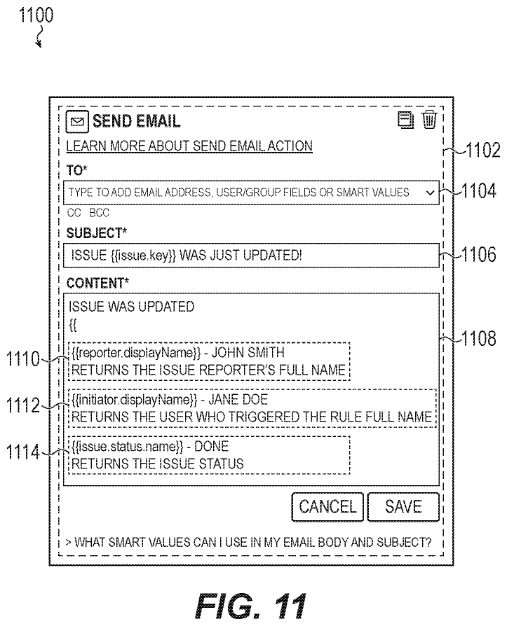

FIGS. 8-11 generally depict examples of special cases and additional features of frontend interfaces. FIG. 8 generally depicts an example of a GUI of a rule builder in the case of a potential incompatibility between one or more automation rule components, such as while creating the rule or during validation. FIG. 9 generally depicts another example of a GUI of a rule builder in the case of a potential incompatibility between one or more automation rule components, such as while creating the rule or during validation. FIGS. 10A-10D generally depict examples of windows for the provision and modifying of parameters and other values for automation rule components, including the use of dynamic text references (e.g., “smart values”). FIG. 11 generally depicts an example of a window for the provision and modifying of parameters where dynamic text references may be suggested.

FIG. 3 depicts an example frontend interface 300 that supports automation rule creation for collaboration platforms, in accordance with aspects described herein. Frontend interface 300 may also be referred to as a UI or GUI. In one or more embodiments, frontend interface 300 may be displayed at a same display or interface as frontend interface 200, for example rendered in response to a user selecting the rule builder button 202. The frontend interface 300 displays the rule builder 302, which includes graphical elements to assist a user in generating an automation rule to operate in a collaboration system (e.g., system 100), as further described herein. In some embodiments, rule builder 302 may be at least a part of a GUI that is rendered by one of first platform backend 108 or second platform backend 110.

In one or more embodiments, rule builder 302 may include a proposed automation flow (or workflow) region and a control region.

Generally, the proposed automation flow region includes graphical elements representing automation rule components. In some examples, the graphical elements representing automation rule components may be replaced during rule building with graphical elements representing selected automation rule components. For example, the proposed automation flow region may include a trigger adding button 310 that may be replaced by a graphical element representing a selected trigger component, and a component adding button 312 that may be replaced by a selected action component. The proposed automation flow region may expand or contract as automation rule components (and their respective graphical elements) are added or deleted.

Generally, the control region may include a search box for automation rule components, tabs for categories of those automation rule components, and graphical elements representing selectable automation rule components.

In one or more embodiments, the rule builder 302 of the frontend interface 300 may include a search box 304, a set of tabs 306, and a set of trigger components 308 in the control region, and a trigger adding button 310 and a component adding button 312 in the automation workflow region. Frontend interface 300 illustrates a simplified view. In some embodiments, rule builder 302 may be embedded within another GUI (e.g., window), or include one or more additional textual and/or graphical elements not shown with reference to frontend interface 300.

The search box 304, the set of tabs 306, and the set of trigger components 308 may be rendered and displayed to a user, for example responsive to the user initiating (starting, entering) the rule builder 302 and selecting the graphical element that is the trigger adding button 310. In some embodiments, after selecting a trigger components for an automation rule, a user may select the graphical element that is the add a component, button 312. In other embodiments, a user may select the graphical element that is the add a button 312 before selecting the trigger component.

The set of trigger components 308 include trigger components that may be used to initiate an automation rule based on an event. In some embodiments, the triggers may be organized into one or more groups or subsets of triggers components. In the example of the frontend interface 300, the groups include recommended, pages and blogs, tasks, spaces, scheduled, and integrations. In this example, the recommended triggers include a manual trigger from a page, a page moved, a page published, or a page status changed. The pages and blogs triggers include a manual trigger from a page, at attachment added to a blogpost, an attachment added to a page, at attachment deleted from a blogpost, an attachment deleted from a page, a blog commented, a blog labeled, a blog published, a page archived, a page comments, a page copied, a page deleted, a page edited, a page labeled, a page moved, a page owner changed, a page published, a page status changed, or a user mentioned. The tasks triggers include task created and task status changed. The spaces triggers include space archived, space created, or space deleted. The scheduled triggers include a scheduled trigger. The integrations triggers include an incoming webhook trigger.

In one or more embodiments, the recommended triggers of the set of trigger components 308 may be based on a usage history for the user, such as the quantity of uses for the trigger component exceeding a threshold value or the user's most used trigger components (e.g., ten most used trigger components). In other embodiments, the recommended triggers are based on the quantity of uses by a group of users (e.g., of the platform, or accessing a centralized automation rule service 112), and may include the most used trigger components or the trigger components whose usage has exceeded a threshold value. In some cases, the recommended triggers may be a curated list within a platform or the centralized automation rule service 112, and may depend on which platform a user is accessing. In some embodiments, the generative output service 116 may be trained on the usage of trigger components for automation rules within a platform or set of platforms, and be used to determine the recommended trigger components based on one or more inputs and a list of potential or candidate trigger components. In some examples, the generative output service 116 can receive (e.g., from the centralized automation rule service 112) information regarding a history of trigger component selections (e.g., for a particular user, group of users, particular platform, or by other groupings), and this information used by the generative output service 116 to provide (e.g., from the centralized automation rule service 112) an indication (e.g., suggestion or recommendation) for a trigger component or set of trigger components 308 (e.g., as the “recommended” trigger components) as part of automation rule building and creation.

The trigger groups for the set of trigger components 308 may be selectable via the set of tabs 306. For example, by selecting the “tasks” selectable element, the set of trigger components 308 may be pared down to display only the associated task triggers 314 (e.g., task created and task status changed), and the other available trigger components hidden.

Search box 304 accepts textual inputs from a user, and in response, the rule builder 302 can filter the set of trigger components 308. In some embodiments, the displayed set of trigger components 308 may be pared down such that only trigger components that satisfy the search are displayed (and other, non-responsive trigger components hidden). In other embodiments, a drop-down or pop-up may be displayed that includes selectable trigger components that satisfy the search.

In some embodiments, trigger components may include one or more of a field value changed, form submitted, incoming webhook, issue assigned, issue commented, issue comment edited, issue created, issue deleted, issue linked, issue link deleted, issue moved, issue transitioned, issue updated, a manual trigger from an issue, a combination of issues, when work is logged, a sprint is created, started, or completed, a version is created, updated, or released, a branch created, build failed, build status changed, build successful, commit created, deployment failed, deployment status changed, deployment successful, pull request create, pull request, declined, pull request merged, vulnerability found, object triggered, service limit breach, a service legal agreement threshold breached, approval required, approval completed, or an emoji reaction to application message. In some embodiments, these example triggers are intended for use with reference to the context of an issue tracking platform.

Additionally, or alternatively, trigger components may include one or more of a page archived, page commented, page copied, page deleted, page edited, page labeled, page moved, page owner changed, page published, page status changed, attachment added to page, attachment deleted from page, attachment deleted from page, manual trigger from page, task created, task status changed, blog commented, blog labeled, blog published, attachment added to blog, attachment deleted from blog, user mentioned, space archived, space created, or a combination of these. In some embodiments, these example triggers are intended for use with reference to the context of a documentation platform.

FIG. 4 depicts an example frontend interface 400 that supports automation rule creation for collaboration platforms, in accordance with aspects described herein. Frontend interface 400 may be an example of frontend interface 300 following selection by a user of the trigger components 308 that are scheduled.

In one or more embodiments, rule builder 302 of the frontend interface 400 may include a component addition box 402 that indicates required and option components for an automation rules. In particular, in addition to a trigger component, an automation rule requires at least one action component. Action components are automation rule components that will execute if the automation rule runs successfully (e.g., based on a detected triggering event) As such, a selectable graphical element for an action component 404 is displayed. Upon selection (e.g., via point click or double-click, or drag and drop to the add component graphical element, such as button 312), action components may be displayed in the rule builder 302 as further discussed herein.

Optionally, an automation rule may use one or more additional components, such as conditions or branch components. As such, component addition box 402 may also include selectable graphical elements for a condition component 406 and a branch component 408.

Condition components are automation rule components that limit the scope of the automation rule to specific user groups or keyworks. For example, a condition may limit a rule to run on a specific path, depending on which condition is met (satisfied). In one or more embodiments, there is a single one of event conditions. In other embodiments, multiple of event conditions are used, and may be set to occur at any point within the automation rule chain. In some embodiments, event condition(s) are in if-then or if-then-else form. In one or more embodiments, examples of event conditions include a user, a database query (e.g., a Confluence querying language (CQL)), such as a query in the form of an “if” statement for a contents of a page, blog, comment, or attachment, a compare, an if-else statement, or a combination of these. In some embodiments, these conditions are for a documentation platform.

In one or more embodiments, examples of event condition(s) include compare functions, which may be values or regular expressions. In one or more embodiments, values for a compare function may include one or more of an issue, conditional logic, users, test fields, date and time, JavaScript Object Notation (JSON) function, math expression, list, or a combination of these. In some embodiments, these conditions are for an issue tracking platform.

Branch components are automation rule components that apply actions and conditions within each branch to each task, each page, and so on. In some embodiments, a branch component is similar to a “for each” requirement.

FIG. 5 depicts an example frontend interface 500 that supports automation rule creation for collaboration platforms, in accordance with aspects described herein. Frontend interface 500 may be an example of frontend interface 300 following selection by a user of the scheduled trigger component from the set of trigger components 308, or frontend interface 400 following selection by a user of the graphical element for the action component 404. The frontend interface 500 displays the rule builder 302, which now includes elements to allow the addition of an action to the automation rule being create and built.

While FIG. 5 generally depicts the selection of an action component for an automation rule flow where all action components are displayed, FIG. 6 more specifically depicts the selection of an action component where only compatible action components are displayed.

In one or more embodiments, rule builder 302 of the frontend interface 500 may include a search box 504, a set of tabs 506, and a set of action components 508. Frontend interface 500 illustrates a simplified view. In some embodiments, rule builder 302 may be embedded within another GUI (e.g., window), or include one or more additional textual and/or graphical elements not shown with reference to frontend interface 500.

Generally, each action component of the set of action components 508 indicates the action to be performed following the trigger component 410 and, if present, if the event condition of the automation rule is met. The action indicates the object on which the action is performed. Actions are what the automation rule is to do or, stated differently, what happens if the automation rule executes successfully.

In some embodiments, the set of action components 508 may be organized into one or more groups or subsets of action components. In the example of the frontend interface 500, the groups include recommended, pages and blogs, spaces, notifications, Jira (e.g., an example of issue tracking system), and advanced. In this example, the recommended actions include a transition an issue in Jira, edit an issue in Jira, add a label, change page status, create issue in Jira, publish a new page, restrict a page, or send an email. The pages and blogs actions include adding a comments, adding a label, archiving a page, change a page owner, change a page status, copy a page, delete a blog, delete a page, manage watchers, move a page, publish a new page, remove a label, or restrict a page. The spaces actions include archiving a space, creating a space, or granting space permissions. The notifications actions include sending an email, sending a message through a first platform (e.g., a Microsoft Teams message), sending a message through a second platform (e.g., a Slack message), sending a message through a third platform (e.g., a Twilio notification), or send a web request. The Jira actions include transitioning an issue, editing an issue, or creating an issue. The advance actions include creating a lookup table, creating a variable, or logging an action.

In one or more embodiments, the recommended action components may be based on a usage history for the user, such as the quantity of uses for the action component exceeding a threshold value or the user's most used trigger components (e.g., ten most used action components). In other embodiments, the recommended actions are based on the quantity of uses by a group of users (e.g., of the platform, or accessing a centralized automation rule service 112), and may include the most used trigger components or the trigger components whose usage has exceeded a threshold value. In some cases, the recommended action components may be a curated list within a platform or the centralized automation rule service 112, and may depend on which platform a user is accessing. In some embodiments, the generative output service 116 may be trained on the usage of action components for automation rules within a platform or set of platforms, and be used to determine the recommended action components based on one or more inputs and a list of potential or candidate trigger components. In some examples, the generative output service 116 can receive (e.g., from the centralized automation rule service 112) information regarding a history of action component selections (e.g., for a particular user, group of users, particular platform, or by other groupings), and this information used by the generative output service 116 to provide (e.g., from the centralized automation rule service 112) an indication (e.g., suggestion or recommendation) for an action component or set of action components 508 (e.g., as the “recommended” trigger components) as part of automation rule building and creation.

The action groups for the set of action components 508 may be selectable via the set of tabs 506. For example, by selecting the “spaces” selectable element, the set of action components 508 may be pared down to display only the associated spaces actions 514 (e.g., archive space, create space, and grant space permission), and the other available action components hidden.

Search box 504 accepts textual inputs from a user, and in response, the rule builder 302 can filter the set of action components 508. In some embodiments, the displayed set of action components 508 may be pared down such that only action components that satisfy the search are displayed (and other, non-responsive action components are hidden). In other embodiments, a drop-down or pop-up may be displayed that includes selectable trigger components that satisfy the search.

In one or more embodiments, actions of the set of action components 508 include one or more of page archiving, page ownership changing, page status changing, page copying, page deletion, page moving, new page publishing, page restriction, blog deletion, comment addition, label addition, label removing, watcher management, space permission adding, space archiving, or a combination of these. In some embodiments, these actions are for a documentation platform.

In one or more embodiments, actions of the set of action components 508 include one or more of email sending, application message sending, text message sending, web request sending, variable creation, action logging, or a combination of these. In some embodiments, these actions are for an issue tracking platform.

FIG. 6 depicts an example frontend interface 600 that supports automation rule creation for collaboration platforms, in accordance with aspects described herein. Frontend interface 600 may be an example of frontend interface 500 following selection by a user of the button for compatible actions 602. Following such selection, the frontend interface 600 then displays a set of compatible action components 604 from the set of action components (e.g., as illustrated with reference to frontend interface 500). Incompatible action components (e.g., those action components of the set of action components 508 that are not in the set of compatible action components 604) are then hidden or otherwise not displayed in the GUI of the rule builder 302. In other embodiments, the action components of the set of compatible action components 604 are flagged or otherwise identified as compatible via an indicator associated with the action component. In some embodiments, action components of the set of action components 508 that are not in the set of compatible action components 604 are flagged or otherwise identified. Compatible and incompatible action components can similarly each be flagged or otherwise identified as compatible or incompatible, respectively.

In one or more embodiments, the recommended action components of the compatible set of action components may be based on a usage history for the user, such as the quantity of uses for the action component exceeding a threshold value or the user's most used trigger components (e.g., ten most used action components). In other embodiments, the recommended actions are based on the quantity of uses by a group of users (e.g., of the platform, or accessing a centralized automation rule service 112), and may include the most used action components or the action components whose usage has exceeded a threshold value. In some cases, the recommended action components may be a curated list within a platform or the centralized automation rule service 112, and may depend on which platform a user is accessing. In some embodiments, the generative output service 116 may be trained on the usage of action components for automation rules within a platform or set of platforms, and be used to determine the recommended action components based on one or more inputs and a list of potential or candidate trigger components.

In some examples, the generative output service 116 can receive (e.g., from the centralized automation rule service 112) information regarding a history of action component selections (e.g., for a particular user, group of users, particular platform, or by other groupings), and this information used by the generative output service 116 to provide (e.g., from the centralized automation rule service 112) an indication (e.g., suggestion or recommendation) for an action component or set of action components 604 (e.g., as the “recommended” trigger components) as part of automation rule building and creation. In some embodiments, the generative output service 116 may be provided with a set automation rule components, including information about each automation rule component, such as one or more of a context and input requirement for each automation rule component. The generative output service 116 can then use the provided automation rule components (e.g., including action components) and information to determine compatible action components 604 associated with a state of the automation rule flow being created by a user, such as already-selected automation rule components (e.g., trigger component 410) and an ordering of the automation rule components in the rule builder 302.

The ordering of the set of compatible action components 604 and/or the content of the set of compatible action components 604 may vary from user to user, user role to user role, and embodiment to embodiment. For example, when interacting with a documentation system, a user having a role of “developer” may be presented with prompts associated with tasks related to an issue tracking system and/or a code repository system.

As an example, for the frontend interface 500, the category of spaces actions 514 includes archive space, create space, and grant space permission. However, in the set of compatible action components 604, the category of spaces actions 606 includes create space, but not archive space and not grant space permission because archive space and grant space permission are incompatible with the trigger component 410.

In one or more embodiments, compatible action components 604 may be those whose addition to the automation rule at a particular position in the automation rule chain is compatible with the current automation rule chain. That is, the action component to be added is compatible with the trigger component and any action components before the position. In one more embodiments, a compatible action component is an action component whose entity context requirements can be satisfied at a position. An action component that cannot satisfy the entity context requirements (e.g., regardless of other components that follow in the automation rule chain) are incompatible. Examples of contexts for system 100 (e.g., one or more platforms of system 100, such as a document management platform) include a database query language context, a rule initiator context, a trigger space context, a dynamic space context, an issue context, or a task context.

By way of examples, a database query language context may be updated and consumed by components that are specific to content, such as pages or blogs, and updated and consumed by components that are more type-agnostic, such as a branch or condition (e.g., a branch or condition for the database query language). The database query language context may support an object that is database query language searchable. A rule initiator context is updated by triggers that are associated with events for a document management platform, and can get set to the person who initiated the event. The rule initiator context may be consumed by a user condition. A trigger context is updated by triggers when the event can be associated with a particular space (e.g., a space of a document management platform). If there is no event with an associated space (e.g., document management platform space), the trigger context can still be set if the rule takes place in space-level automation. A dynamic space context may be updated by any component that outputs a dynamic text reference (which may also be referred to as a “smart value”) for a space (e.g., “{{space}}”). An issue context may be used for integrations to an issue tracking platform. A task context may be used for action that operate on tasks (e.g., an update task status action component).

In some cases, action component may be required and update the same context. For example, a move page action component may need to define an update to database query language context and also require the database query language context. In some embodiments, all actions may declare their outputs for consistency, which may help to facilitate the static analysis of automation rules, and in particular validating component compatibility. In one example, the following automation rules may be valid only sometimes: task created trigger component followed by move page action component (Task Created→Move page). In one example, if the task from the trigger was added to a page, then the ‘Move page’ action will execute successfully. But if the task from the trigger was added to a blogpost, then the ‘Move page’ action will fail. As such, this automation rule may be valid in some automation rules, but not others. As such, following the task created trigger component, the move page action component can be indicated as compatible and available for selection, even though the automation rule may not successfully later validate. In some embodiments, incompatible components thus are those components that will be definitely incompatible (e.g., definitely result in an invalid automation rule). As an example, the following automation rules would all pass rule validation: Task created→Move page; Task created→Delete blog; Task created→Move page→Add label; and Task created→Move page→Restrict page. However, the following rule would not pass validation: Task created→Move page→Delete blogpost. By the time ‘Delete blogpost’ action component executes, the database query language context must contain a page, because otherwise the ‘Move page’ action would not have finished executing. But in order to distinguish this case from the others during static analysis (e.g., for rule validation, the ‘Move page’ action component must be defined to set the database query language context to a page specifically. As such, even if the type is unknown before the ‘Move page’ action, the type after the ‘Move page’ action is known.

In one or more embodiments, a context graph may be defined and used to validate an automation rule and/or determine which components (e.g., action components) are compatible to add to an automation rule. An example of using a context graph follows.

In one example, call the set of all entity contexts for a system or platform C. In some embodiments, the set C is different for each system or platform. For example, a document management platform may have some entity contexts that an issue tracking platform does not have, and vice versa. However, some entity contexts may be shared between systems or platforms. Define an “entity context state” s to be a set of tuples <c, possibleTypes> where c is an entity context and possibleTypes is a subset of c.supportedTypes. Every s must have one element <c, possibleTypes> for every c in C (in other words, no entity contexts can be left out of a state). Each s represents the state of all the entity contexts at a particular point in a rule. Each member reveals what types may be present in the respective entity context. An entity context may only contain one type at a time, but that type may be undetermined at rule creation time (e.g., as a result a context can be mapped to multiple types).

Define a “context node” n to be a tuple <satisfied, update, children> where: satisfied is a function that accepts an entity context state and returns true or false (true if the entity context state can possibly satisfy the requirements of n; and false if the entity context state cannot satisfy the requirements of n); update is a function that accepts an entity context state and returns another (possibly identical) entity context state; and children is a (possibly empty) list of lists of context nodes. In one or more embodiments, satisfied only returns false if the state cannot satisfy the requirements. Each context node corresponds to a component in the rule builder. Define a “context graph” to be a list of context nodes, representing some chunk of an automation rule.

The following pseudocode is an example that defines a function to return all unsatisfied nodes from a context graph:
func find_invalid(graph, prior_state=null):
   var invalid=new Set( )
   var state
   if prior_state!=null:
   state=copy_of(prior_state)
else:
   state=new Set( )
for node in graph:
   #check if node is invalid given current state
   if not node.satisfied(state):
      invalid.add(node)
   #do not mutate the current state right away
   var local_state=node.update(state)
   #recursively process children
   for child_graph in node.children:
      invalid.add(find_invalid(child_graph, local_state))
   #only mutate current state if do not have children
   if node.children.length==0:
      state=local_state

In one or more embodiment, context persists only within the scope of a branch of an automation rule. In some embodiments, the validation traverses to all edges of a branch.

FIG. 7 depicts an example frontend interface 700 that supports automation rule creation for collaboration platforms, in accordance with aspects described herein. Frontend interface 700 may be an example of frontend interface 500 and/or frontend interface 600 following selection by a user of one of action components from the set of compatible action components 604 (or the action components 508), and in particular after the action components of publish new page 710, add label 712, restrict page 714, and delete page 716 were selected and added to the automation rule chain shown for example frontend interface 700.

Following the selection and addition of the action components shown with reference to frontend interface 700, the quantity of compatible action components may be further limited. For example, in addition to being compatible with the trigger component 410, each action component may also need to be compatible with each other action component before the current action component under consideration. According to the illustrated example, the action component 718 needs to be compatible with the publish new page 710, add label 712, restrict page 714, and delete page 716 action components in addition to the trigger component 410 that is scheduled. As such, when a user selects the compatible actions button 702 of the set of tabs 506, the action components 704 that are displayed are those that are compatible with the whole, current automation rule. In one or more examples, the action components 704 that are compatible include those in groups of recommended, pages and blogs, and spaces. The recommended action components include a transition an issue in Jira, edit an issue in Jira, create issue in Jira, publish a new page, or send an email. The pages and blogs group includes only a single action component: publish new page. The spaces actions 706 include archiving a space, creating a space, or granting space permissions. By contrast, the pages and blogs group 516 illustrated with reference to the frontend interface 500 contained thirteen action components.

In one or more embodiments, a fewer quantity of action components may be available as compatible later in the process of creating an automation rule. However, in some embodiments, a greater quantity of action components may be available as compatible later in the process of creating the automation rule. For example, following selection of the trigger component 410 that is scheduled, for example as described with reference to the frontend interface 600, the compatible actions 602 may include only a single action component for spaces actions 606: the create space action component. However, following the addition of one or more action components, three different action components for spaces actions 514 may be available or indicated as compatible (e.g., archive space, create space, and grant space permission action components).

FIG. 8 depicts an example frontend interface 800 that supports automation rule creation for collaboration platforms, in accordance with aspects described herein. Frontend interface 800 includes a rule builder 302 that displays a trigger component 802 for scheduling, and an action component 804 for page archiving. However, in this instance, the action component 804 for page archiving may be incompatible with the trigger component 802 for scheduling. The system (e.g., system 100, including one or more of the first platform backend 108 or the second platform backend 110) with which a user (e.g., via client device 104 or client device 106) is interacting may identify that one or more compatibility criteria are not satisfied. In response, the system may render in the GUI of the rule builder 302, a narrative 806 including content related to a potential incompatibility between one or more adjacent components. In some embodiments, the narrative 806 may be rendered together with a narrative 808 that includes a description for the action component 804 for which the narrative 806 is generated.

FIG. 9 depicts an example frontend interface 900 that supports automation rule creation for collaboration platforms, in accordance with aspects described herein. Frontend interface 900 includes a rule builder 302 that displays a trigger component 902 for scheduling, an action component 904 for adding a comment to a page, and an action component 906 for archiving a page.

In this example, the action component 904 and the action component 906 may be incompatible with the trigger component 902 for scheduling. The system with which a user is interacting may identify that one or more compatibility criteria are not satisfied. In response, the system may render in the GUI of the rule builder 302, a narrative 912 including content related to a potential incompatibility between one or more adjacent components. In one or more embodiments, the narrative 912 may describe the error and/or suggest one or more ways in which the error can be resolved. The rule builder 302 may determine compatibility when an action component is added to the automation rule that is being created, such that the narrative 912 may be present when the incompatible action component is added to the rule, or updated when further incompatible actions are added, removed, or otherwise modified in the case of multiple incompatible automation rule components. In some embodiments, one or more indicators 908 (e.g., identifiers, flags, or other graphical elements), such as the illustrated exclamation points within a diamond, may be rendered on the graphical elements for the action component 904 and action component 906 to provide a visual cue to the user of the source of the error.

In the example of frontend interface 900, the action component 904 has been configured to add a comment that includes one or more dynamic text reference 910. Upon running the automation rule, the action component 904 will add a comment to a page in the form “Hey {{page.author}} we've archived this page . . . ” As part of running of the automation rule, the dynamic text reference “{{page.author}}” will replaced with the page author for the associated page, where the page author may be a part of the metadata or other information associated with the page to which the comment is being added. In some embodiments, the dynamic text reference 910 may be referred to as a “smart value.”

FIGS. 10A-10D depict examples of a first portion 1001 (FIG. 10A), a second portion 1002 (FIG. 10B), a third portion 1003 (FIG. 10C), and a fourth portion 1004 (FIG. 10D) of a frontend interface that supports automation rule creation for collaboration platforms, in accordance with aspects described herein.

The first portion 1001 of the frontend interface illustrates at least a part of a display rendered for a GUI for an automation rule builder, as further discussed herein, that displays portions (e.g., a draft portion) of an automation rule that is being created. The automation rule includes a trigger component 1010, a condition component 1012, and an action component 1014. A graphical element 1016 (e.g., an “add component” button) can be selected to provide an interface for a user to select additional automation rule components (e.g., actions, conditions, branches, and so on).

The second portion 1002 of the frontend interface illustrates at least a part of a display rendered for a GUI for the automation rule builder. The second portion 1002 includes an interface for modification of the trigger component 1010, including input fields and selection interfaces (e.g., dropdowns) for a frequency to run the rule, a day of the week to run the rule, and a time to run the rule (e.g., including a selection for the time zone). Narrative descriptions of the rule, and an indication of a date and time at which the rule will run may also be included.

The third portion 1003 of the frontend interface illustrates at least a part of a display rendered for a GUI for the automation rule builder. In the example of the third portion 1003, a dynamic text reference (e.g., a “smart value”) and/or regular expression may be compared with another dynamic text reference and/or regular expression. The third portion 1003 includes an interface for modification of the condition component 1012, including a narrative portion 1030 that describes the condition component 1012. The third portion 1003 includes inputs and interfaces for modification of the condition component 1012, including input fields and selection interfaces (e.g., dropdowns). In this example, the third portion 1003 includes a first input field 1034 for a first value and a second input field 1038 for a second value. A third input field 1036 specifies the condition to compare the first value with the second value. In this examples, a dynamic text reference, such as {{page.title.toLowerCase( )}} (the page title in lowercase) is compared with the regular expression “meeting notes.” If the page title includes the regular expression “meeting notes,” then the condition returns true. Because the condition is true, the automation rule proceeds to the next automation rule component, which is the action component 1014.

The fourth portion 1004 of the frontend interface illustrates at least a part of a display rendered for a GUI for the automation rule builder. In the example of the fourth portion 1004, dynamic text references (e.g., “smart values”) and/or regular expression may can be used to populate portions of a template, in this case for an email to be sent according to the automation rule. The fourth portion 1004 includes interfaces for modification of the action component 1014, including a narrative portion 1040 that describes the action component 1014 (“Send an email with an AI-generated summary and action items when a meeting notes page is published.”).

The fourth portion 1004 also includes inputs and interfaces 1042 for modification of the action component 1014, including input fields and selection interfaces (e.g., dropdowns). In this example, the fourth portion 1004 includes a first input field 1044 for email addresses, which may also be populated via a dropdown selection. In some cases, the email addresses may be auto-populated as a user types (e.g., all emails within a domain or other grouping that start with “st” are displayed in a selectable list when a user has input the letters “st” into the first input field 1044).

A second field 1046 and a third field 1048 may include regular expressions, one or more dynamic text references, or a combination of regular expressions and dynamic text references. For example, as shown for the fourth portion 1004, the second field 1046 recites “Summary and action items for page ‘{{page.title}}’” such that the title of the page acted on by the action component 1014 is inserted in the subject line of the email to replace {{page.title}}.

The third field 1048 includes a first dynamic text reference 1050 and a second dynamic text reference 1052. The first dynamic text reference 1050 may be a request for generative output service (e.g., generative output service 116) to insert a summary of a page into a text description in the third field 1048. In some examples, when the automation rule containing the dynamic text reference is run, the centralized automation rule service 112 may provide a request to the prompt management service 114 that prepares a prompt for the generative output engine that is based on the dynamic text reference, then provides the prompt to the generative output service 116, which prepares a response. The response is provided back to the prompt management service 114 and centralized automation rule service 112, then the platform backend from which the automation rule is being run. For example, for the first dynamic text reference 1050, {{page.aiSummary}}, a prompt may be generated that includes text from the page (or at least a portion of the page) and information regarding a format, parameters, example outputs, and so on for generating the summary. For the second dynamic text reference 1052, {{page.aiActionItems}}, a prompt may be generated that includes text from the page (or at least a portion of the page) and information regarding a format for the action items, parameters, example outputs, and so on for generating a set or list of action items. Responses are then provided by the generative output service 116, and the responses inserted in the email body to replace {{page.aiSummary}} and {{page.aiActionItems}} in the third field 1048 (e.g., the email body).

FIG. 11 depicts an example of a portion 1100 of a frontend interface that supports automation rule creation for collaboration platforms, in accordance with aspects described herein. In particular, portion 1100 illustrates a UI to edit (customize, modify, create) an action component 1102 to send an email including specified criteria as part of an automation rule.

In this example, the portion 1100 includes a first input field 1044 for email addresses, which may be populated via a text entry, or be populated via a dropdown selection. In some cases, the email addresses may be auto-populated as a user types.

A second input field 1006 and a third input field 1008 may include regular expressions, one or more dynamic text references, or a combination of regular expressions and dynamic text references. For example, the second input field 1006 recites “Issue {{issue.key}} was just updated!” such that the issue key associated with an issue (e.g., in an issue tracking system) is inserted in the subject line of the email to replace {{issue.key}}.

The second input field 1006 and/or the third input field 1008 may also include one or more dynamic text references that may be auto-populated as a user types. For example, if a user types “{{” to begin a dynamic text reference, then the system may identify and render a set (e.g., as a dropdown or other listing) of dynamic text references. In some embodiments, the identified and rendered dynamic text reference may be those that the system identifies as compatible with the current action component, as well as compatible with prior action components and/or trigger components for the automation rule to which the portion 1100 applies. For example, as illustrated for the third input field 1008, for sending an email in this context (e.g., triggered based on a trigger component in an issue tracking system), there may be three dynamic text references that are compatible: a first dynamic text reference 1110 that returns an issue reporter's full name (e.g., {{reporter.displayName}}), a second dynamic text reference 1112 that returns the full name of the user that triggered the rule (e.g., {{initiator.displayName}}), and a third dynamic text reference 1114 that returns an issue's status (e.g., {{issue.status.name}}). In some embodiments, the dynamic text references may be provided alphabetically. In other embodiments, the dynamic text references may be provided in order of a frequency of use by a user or a group of users, or for a particular platform.

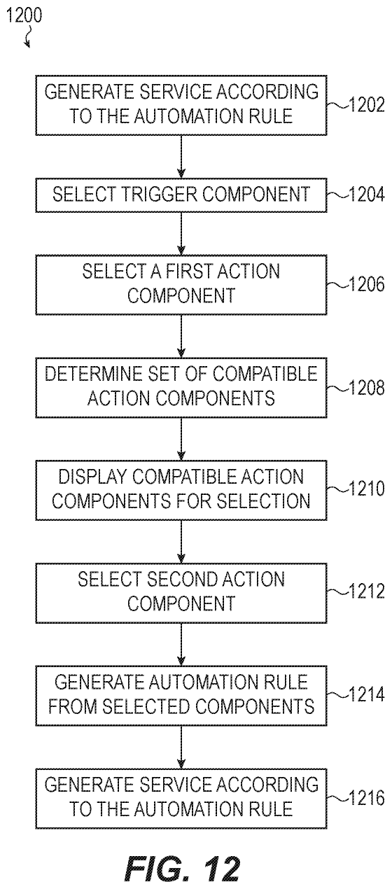

FIG. 12 shows an example method 1200 of automation rule creation, for example in collaboration platforms, according to one or more aspects described herein. In one or more embodiments, method 1200 supports one or more aspects of automation rule creation, as further described herein, for example with reference to any one or more of FIGS. 1-11. The method 1200 may be performed using a processor and/or memory, or other components of the content collaboration system.

At 1202, the method 1200 includes generating a GUI with an automation rule input field. In some embodiments, the method 1200 includes causing generation of a GUI of the collaboration system, the GUI including an input field for receiving user input. In some embodiments, the trigger component is associated with a change to a first object of the collaboration system.

At 1204, the method 1200 includes selecting a trigger component. In some embodiments, the method 1200 includes receiving a first input of the GUI indicating a selection of the trigger component for an automation rule. In one or more embodiments, the method 1200 includes causing generation of a first one or more graphical elements representing the selected trigger component in the graphical user interface. In some embodiments, the generation is in response to receiving an input of the graphical user interface indicating the selection of the trigger component.

At 1206, the method 1200 includes selecting a first action component. In some embodiments, the method 1200 includes receiving a first input of the GUI indicating a selection of the first action component for an automation rule. In some embodiments, the method 1200 includes causing generation of a first one or more graphical elements representing the selected first action component in the graphical user interface. In some embodiments, the generation is in response to receiving an input of the graphical user interface indicating the selection of the first action component.

At 1208, the method 1200 includes determining a set of compatible action components. In some embodiments, the method 1200 includes determining a first set of compatible action components for the selected first action component based at least in part on, for each action of the first set of compatible action components, an ordering of the action within the automation rule and a compatibility between the action and the selected first action component. In some embodiments, the determining is in response to receiving an input of the graphical user interface indicating the selection of the triggering components, the first action component, or both.

At 1210, the method 1200 includes displaying compatible action components for selection. In one or more embodiments, the method 1200 further includes causing generation of a first set of graphical elements in the graphical user interface, each graphical element of the first set of graphical elements corresponding to a respective action of the first set of compatible action components. In some embodiments, the generation is in response to receiving an input of the graphical user interface indicating the selection of the triggering components, the first action component, or both.

At 1212, the method 1200 includes selecting a second action component. In one or more embodiments, the method 1200 includes selecting a compatible action component (the second action component) from the first set of compatible action components. In some embodiments, the method 1200 further includes causing generation of a second graphical element representing the selected compatible action component in the graphical user interface. In one or more embodiments, the generation is in response to receiving a second input of the GUI indicating the selection of a compatible action component from the first set of compatible action components.

At 1214, the method 1200 includes generating an automation rule based on the selected components. In one or more embodiments, the method 1200 includes saving an automation rule that includes at least the selected trigger component, the selected compatible action component, and an object identifier. In some embodiments, the saving is in response to receiving a third input of the graphical user interface indicating for the collaboration system to save the automation rule.

At 1216, the method 1200 includes generating a service according to the automation rule. In one or more embodiments, the method 1200 includes generating a service on the collaboration system that performs an operation in response to an event satisfying the selected trigger component. In some embodiments, the operation corresponds to the action component. In some embodiments, the operation is further performed on a set of objects selected using the object identifier.

In one or more embodiments, the method 1200 further includes enabling the service. In some embodiments, the enabling may be in response to each component of the automation rule satisfying a compatibility criteria with each respective adjacent component of the automation rule. In one or more embodiments, the method 1200 further includes causing display of a narrative including content related to a potential incompatibility between one or more adjacent components. In some embodiments, the displaying may be in response to each component of the automation rule not satisfying the compatibility criteria with each respective adjacent component of the automation rule.

In one or more embodiments, the method 1200 further includes determining, for each action component of the first set of compatible action components, whether a user of the collaboration system has permission to perform an action associated with the action component. In some embodiments, the determining includes determining whether the user has permission to access a platform of the collaboration system that is associated with the action. In some embodiments, the method further includes causing display of the action component in response to determining that the user has permission to access the platform.

In one or more embodiments, the method 1200 further includes determining whether a user of the collaboration system has permission to access a content item of the collaboration system that is referenced by the action. In some embodiments, the method 1200 further includes causing display of the action component in response to determining that the user has permission to access the content item.

In one or more embodiments, the method 1200 further includes performing a validation check on the automation rule and, in response to identifying that the validation check has failed for the automation rule, causing generation of a graphical element flagging the automation rule as invalid. In some embodiments, the validation check includes verifying that each action component of the automation rule has all required inputs. In some embodiments, the third graphical element flagging the automation rule as invalid is caused to be generated in proximity to an invalid action. In some embodiments, the method 1200 further includes, in response to identifying that the validation check has failed for the automation rule, causing generation of one or more natural language strings that suggest a fix for the automation rule.

In one or more embodiments, the method 1200 further includes causing generation of an input field for receiving a user input to define one or more inputs to the compatible action component. In some embodiments, the second graphical element is generated at least in part in response to receiving the user input for the compatible action component. In some embodiments, the generation is in response to receiving the second input of the GUI indicating the selection of the compatible action component from the first set of compatible action components.

In one or more embodiments, the method 1200 further includes determining a set of one or more potential values consistent with the one or more characters entered in the input field, and causing generation of a selectable list based on the set of one or more potential values. In some embodiments, the valid input to the input field comprises a selection of a value of the selectable list. In some embodiments, the determining and generation are in response to one or more characters entered in the input field for receiving the user input for the compatible action component.

In one or more embodiments, the method 1200 further includes determining a set of one or more potential values consistent with the one or more characters entered in the input field, and causing generation of a suggestion of at least one potential value of the set of one or more potential values within the input field for the user input. In some embodiments, the valid input to the input field comprises a selection of the suggestion of the at least one potential value. In some embodiments, the determining and generation are in response to one or more characters entered in the input field for receiving the user input for the compatible action component.

In one or more embodiments, the method 1200 further includes transmitting a call to a generative output engine that includes a prompt that is based at least in part on a content item of the collaboration system, and obtaining, from the generative output engine and in response to the prompt, a generative output for inclusion in the input field. In some embodiments, the valid input to the input field for the compatible action component includes a reference configured to cause the collaboration system to perform the transmitting and obtaining.

In one or more embodiments, causing generation of the first set of graphical elements includes arranging the first set of graphical elements in the graphical user interface according to an order that is based at least in part on a ranking of actions of the first set of compatible action components.

In one or more embodiments, the first object is of a first platform of the collaboration system, and the first action component or at least one of the first set of compatible action components are of a second platform of the collaboration system.

The method 1200 may be variously embodied, extended, or adapted, as described in the following paragraphs and elsewhere in this description.

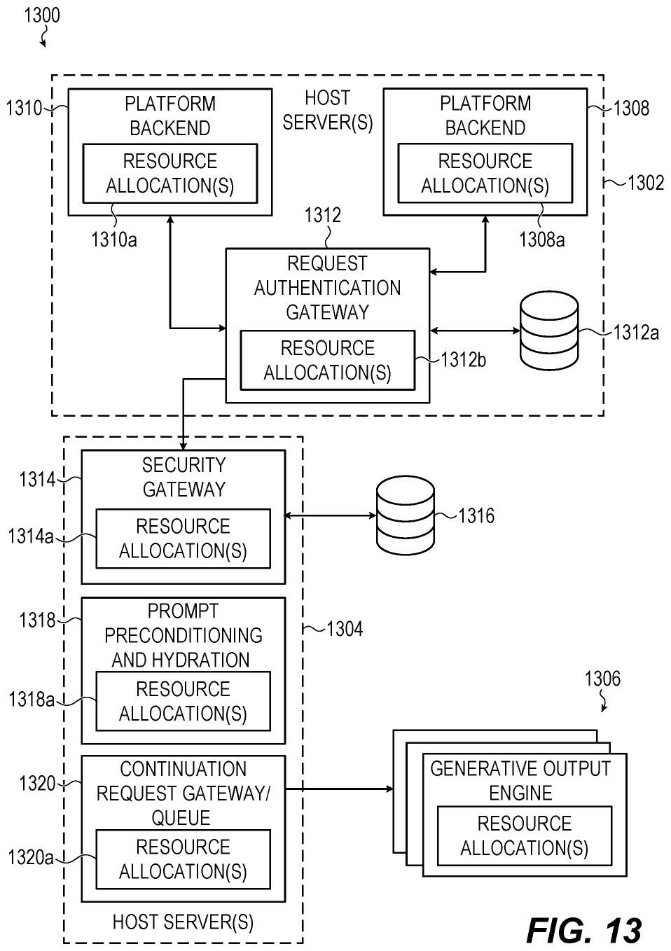

FIG. 13 depicts a system diagram and network/communication architectures that may support a system as described herein. The system 1300 includes a first set of host servers 1302 associated with one or more software platform backends. These software platform backends can be communicably coupled to a second set of host servers 1304 purpose configured to process requests and responses to and from one or more generative output engines 1306.

Specifically, the first set of host servers 1302 (which, as described above can include processors, memory, storage, network communications, and any other suitable physical hardware cooperating to instantiate software) can allocate certain resources to instantiate a first and second platform backend, such as a first platform backend 1308 and a second platform backend 1310. Each of these respective backends can be instantiated by cooperation of processing and memory resources associated to each respective backend. As illustrated, such dedicated resources are identified as the resource allocations 1308a and the resource allocations 1310a.

Each of these platform backends can be communicably coupled to an authentication gateway 1312 configured to verify, by querying a permissions table, directory service, or other authentication system (represented by the database 1312a) whether a particular request for generative output from a particular user is authorized. Specifically, the second platform backend 1310 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 1312 can deny the request for insufficient permissions. This example is merely one and is not intended to be limiting; many possible authorization and authentication operations can be performed by the authentication gateway 1312. The authentication gateway 1312 may be supported by physical hardware resources, such as a processor and memory, represented by the resource allocations 1312b.

Once the authentication gateway 1312 determines that a request from a user of either platform is authorized to access data or resources implicated in service that request, the request may be passed to a security gateway 1314, which may be a software instance supported by physical hardware identified in FIG. 13 as the resource allocations 1314a. The security gateway 1314 may be configured to determine whether the request itself conforms to one or more policies or rules (data and/or executable representations of which may be stored in a database 1316) established by the organization. For example, the organization may prohibit executing prompts for offensive content, value-incompatible content, personally identifying information, health information, trade secret information, unreleased product information, secret project information, and the like. In other cases, a request may be denied by the security gateway 1314 if the prompt requests beyond a threshold quantity of data.

Once a particular user-initiated prompt has been sufficiently authorized and cleared against organization-specific generative output rules, the request/prompt can be passed to a preconditioning and hydration service 1318 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 1318 can be a software instance supported by physical hardware represented by the resource allocations 1318a. In some implementations, the hydration service 1318 may also be used to rehydrate personally identifiable information (PII) or other potentially sensitive data that has been extracted from a request or data exchange in the system.

One a prompt has been modified, replaced, or hydrated by the preconditioning and hydration service 1318, it may be passed to an output gateway 1320 (also referred to as a continuation gateway or an output queue). The output gateway 1320 may be responsible for enqueuing and/or ordering different requests from different users or different software platforms based on priority, time order, or other metrics. The output gateway 1320 can also serve to meter requests to the generative output engines 1306.

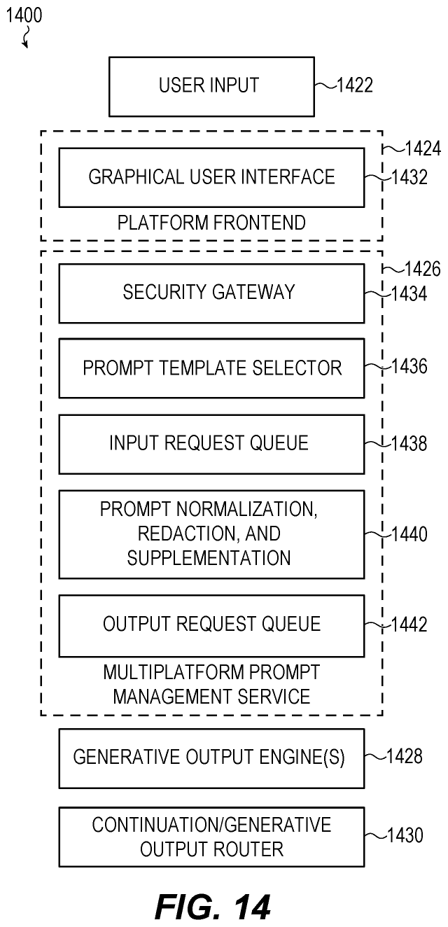

FIG. 14 depicts a functional system diagram of the system 1300. In particular, the system 1400 is configured to operate as a multiplatform prompt management service supporting and ordering requests from multiple users across multiple platforms. In particular, a user input 1422 may be received at a platform frontend 1424. The platform frontend 1424 passes the input to a prompt management service 1426 that formalizes a prompt suitable for input to a generative output engine 1428, which in turn can provide its output to an output router 1460 that may direct generative output to a suitable destination. For example, the output router 1460 may execute API requests generated by the generative output engine 1428, may submit text responses back to the platform frontend 1424, may wrap a text output of the generative output engine 1428 in an API request to update a backend of the platform associated with the platform frontend 1424, or may perform other operations.

Specifically, the user input 1422 (which may be an engagement with a button, typed text input, spoken input, chat box input, and the like) can be provided to a graphical user interface 1432 of the platform frontend 1424. The graphical user interface 1432 can be communicably coupled to a security gateway 1434 of the prompt management service 1426 that may be configured to determine whether the user input 1422 is authorized to execute and/or complies with organization-specific rules.

The security gateway 1434 may provide output to a prompt selector 1436 which can be configured to select a prompt template from a database of preconfigured prompts, templatized prompts, or engineered templatized prompts. Once the raw user input is transformed into a string prompt, the prompt may be provided as input to a request queue 1438 that orders different user request for input from the generative output engine 1428. Output of the request queue 1438 can be provided as input to a prompt hydrator 1440 configured to populate template fields, add context identifiers, supplement the prompt, and perform other normalization operations described herein. In other cases, the prompt hydrator 1440 can be configured to segment a single prompt into multiple discrete requests, which may be interdependent or may be independent.

Thereafter, the modified prompt(s) can be provided as input to an output queue at 1442 that may serve to meter inputs provided to the generative output engine 1428.

These foregoing embodiments depicted in FIG. 13-14 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

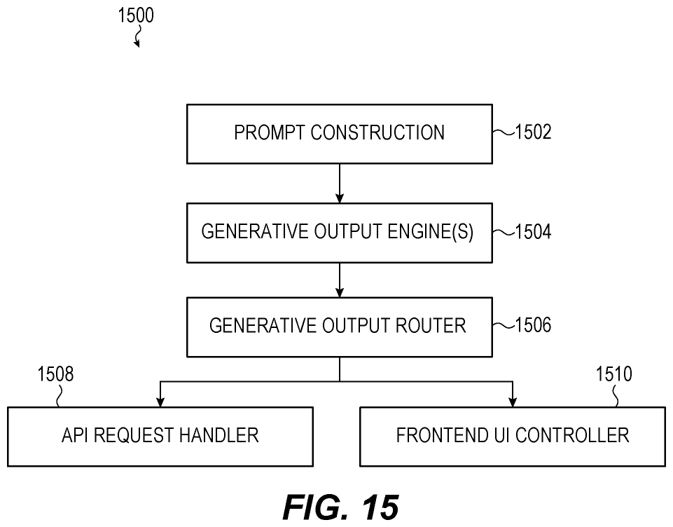

Although many constructions are possible, FIG. 15 depicts a simplified system diagram and data processing pipeline as described herein. The system 1500 receives user input, and constructs a prompt therefrom at operation 1502. After constructing a suitable prompt, and populating template fields, selecting appropriate instructions and examples for an LLM to continue, the modified constructed prompt is provided as input to a generative output engine 1504. A continuation from the generative output engine 1504 is provided as input to a router 1506 configured to classify the output of the generative output engine 1504 as being directed to one or more destinations. For example, the router 1506 may determine that a particular generative output is an API request that should be executed against a particular API (e.g., such as an API of a system or platform as described herein). In this example, the router 1506 may direct the output to an API request handler 1508. In another example, the router 1506 may determine that the generative output may be suitably directed to a graphical user interface/frontend. For example, a generative output may include suggestions to be shown to a user below a user's partial input, such as shown in FIGS. 3-11.

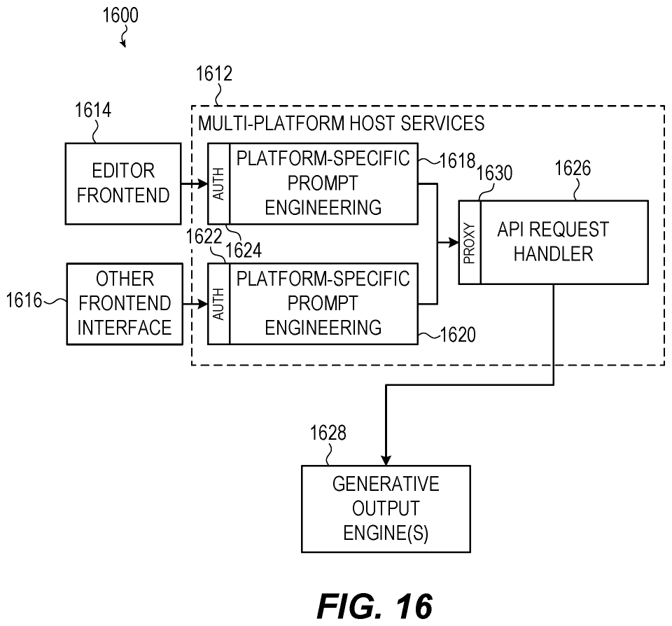

Another example architecture is shown in FIG. 16, illustrating a system providing prompt management, and in particular multiplatform prompt management as a service. The system 1600 is instantiated over cloud resources, which may be provisioned from a pool of resources in one or more locations (e.g., datacenters). In the illustrated embodiment, the provisioned resources are identified as the multi-platform host services 1612.

The multi-platform host services 1612 can receive input from one or more users in a variety of ways. For example, some users may provide input via an editor region 1614 of a frontend, such as described above. Other users may provide input by engaging with other user interface elements 1616 unrelated to common or shared features across multiple platforms. Specifically, the second user may provide input to the multi-platform host services 1612 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 1612 can include multiple software instances or microservices each configured to receive user inputs and/or proposed prompts and configured to provide, as output, an engineered prompt. In many cases, these instances—shown in the figure as the platform-specific prompt engineering services 1618, 1620—can be configured to wrap proposed prompts within engineered prompts retrieved from a database such as described above.

In many cases, the platform-specific prompt engineering services 1618, 1620 can be each configured to authenticate requests received from various sources. In other cases, requests from editor regions or other user interface elements of particular frontends can be first received by one or more authenticator instances, such as the authentication instances 1622, 1624. In other cases, a single centralized authentication service can provide authentication as a service to each request before it is forwarded to the platform-specific prompt engineering services 1618, 1620.

Once a prompt has been engineered/supplemented by one of the platform-specific prompt engineering services 1618, 1620, it may be passed to a request queue/API request handler 1626 configured to generate an API request directed to a generative output engine 1628 including appropriate API tokens and the engineered prompt as a portion of the body of the API request. In some cases, a service proxy 1630 can interpose the platform-specific prompt engineering services 1618, 1620 and the request queue/API request handler 1626, so as to further modify or validate prompts prior to wrapping those prompts in an API call to the generative output engine 1628 by the request queue/API request handler 1626 although this is not required of all embodiments.

These foregoing embodiments depicted in FIGS. 15-16 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

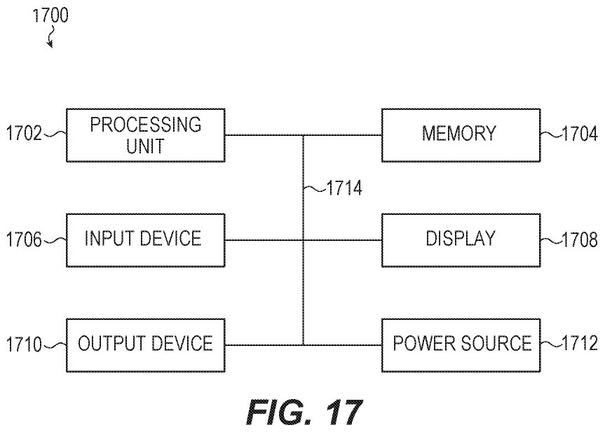

FIG. 17 shows a sample electrical block diagram of an electronic device 1700 that may perform the operations described herein. The electronic device 1700 may in some cases take the form of any of the electronic devices described with reference to FIGS. 1-16, including client devices, and/or servers or other computing devices associated with the system 100. The electronic device 1700 can include one or more of a processing unit 1702, a memory 1704 or storage device, input devices 1706, a display 1708, output devices 1710, and a power source 1712. In some cases, various implementations of the electronic device 1700 may lack some or all of these components and/or include additional or alternative components.

The processing unit 1702 can control some or all of the operations of the electronic device 1700. The processing unit 1702 can communicate, either directly or indirectly, with some or all of the components of the electronic device 1700. For example, a system bus or other communication mechanism 1714 can provide communication between the processing unit 1702, the power source 1712, the memory 1704, the input device(s) 1706, and the output device(s) 1710.

The processing unit 1702 can be implemented as any electronic device capable of processing, receiving, or transmitting data or instructions. For example, the processing unit 1702 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1700 can be controlled by multiple processing units. For example, select components of the electronic device 1700 (e.g., an input device 1706) may be controlled by a first processing unit and other components of the electronic device 1700 (e.g., the display 1708) may be controlled by a second processing unit, where the first and second processing units may or may not be in communication with each other.

The power source 1712 can be implemented with any device capable of providing energy to the electronic device 1700. For example, the power source 1712 may be one or more batteries or rechargeable batteries. Additionally, or alternatively, the power source 1712 can be a power connector or power cord that connects the electronic device 1700 to another power source, such as a wall outlet.

The memory 1704 can store electronic data that can be used by the electronic device 1700. For example, the memory 1704 can store electronic data or content such as, for example, audio and video files, documents and applications, device settings and user preferences, timing signals, control signals, and data structures or databases. The memory 1704 can be configured as any type of memory. By way of example only, the memory 1704 can be implemented as random access memory, read-only memory, flash memory, removable memory, other types of storage elements, or combinations of such devices.

In various embodiments, the display 1708 provides a graphical output, for example associated with an operating system, user interface, and/or applications of the electronic device 1700 (e.g., a chat user interface, an issue-tracking user interface, an issue-discovery user interface, etc.). In one embodiment, the display 1708 includes one or more sensors and is configured as a touch-sensitive (e.g., single-touch, multi-touch) and/or force-sensitive display to receive inputs from a user. For example, the display 1708 may be integrated with a touch sensor (e.g., a capacitive touch sensor) and/or a force sensor to provide a touch- and/or force-sensitive display. The display 1708 is operably coupled to the processing unit 1702 of the electronic device 1700.

The display 1708 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1708 is positioned beneath and viewable through a cover that forms at least a portion of an enclosure of the electronic device 1700.

In various embodiments, the input devices 1706 may include any suitable components for detecting inputs. Examples of input devices 1706 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1706 may be configured to detect one or more particular types of input and provide a signal (e.g., an input signal) corresponding to the detected input. The signal may be provided, for example, to the processing unit 1702.

As discussed above, in some cases, the input device(s) 1706 include a touch sensor (e.g., a capacitive touch sensor) integrated with the display 1708 to provide a touch-sensitive display. Similarly, in some cases, the input device(s) 1706 include a force sensor (e.g., a capacitive force sensor) integrated with the display 1708 to provide a force-sensitive display.

The output devices 1710 may include any suitable components for providing outputs. Examples of output devices 1710 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 1710 may be configured to receive one or more signals (e.g., an output signal provided by the processing unit 1702) and provide an output corresponding to the signal.

In some cases, input devices 1706 and output devices 1710 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1702 may be operably coupled to the input devices 1706 and the output devices 1710. The processing unit 1702 may be adapted to exchange signals with the input devices 1706 and the output devices 1710. For example, the processing unit 1702 may receive an input signal from an input device 1706 that corresponds to an input detected by the input device 1706. The processing unit 1702 may interpret the received input signal to determine whether to provide and/or change one or more outputs in response to the input signal. The processing unit 1702 may then send an output signal to one or more of the output devices 1710, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for automation rule creation within a collaboration system, the method comprising:
causing generation of a graphical user interface of the collaboration system, the graphical user interface including an input field for receiving user input;
in response to receiving a first input of the graphical user interface indicating a selection of a trigger component and a first action component for an automation rule, the trigger component associated with a change to a first object of the collaboration system:
causing generation of a first one or more graphical elements representing the selected trigger component and the selected first action component in a proposed automation rule flow in the graphical user interface;
determining a first set of compatible action components for the selected first action component based at least in part on, for each action component of the first set of compatible action components, an ordering of the action component within the proposed automation rule flow and a compatibility between the action component and the selected first action component; and
causing generation of a first set of graphical elements in the proposed automation rule flow, each graphical element of the first set of graphical elements corresponding to a respective compatible action component of the first set of compatible action components;
in response to receiving a second input of the graphical user interface indicating a selection of a particular compatible action component from the first set of compatible action components:
causing generation of a second graphical element representing the selected compatible action component, the second graphical element displayed with the first one or more graphical elements in the proposed automation rule flow;
in response to receiving a third input of the graphical user interface indicating for the collaboration system to save an automation rule that includes at least the selected trigger component, the first action component, the selected compatible action component, and an object identifier:
generating a service on the collaboration system that performs an operation in response to an event satisfying the selected trigger component, wherein the operation corresponds to the action component, and the operation is performed on a set of objects selected using the object identifier.

2. The computer-implemented method of claim 1, wherein the collaboration system comprises:
a first platform backend to support a first platform of the collaboration system, the trigger component associated with a change to a first object of the first platform; and
a second platform backend to support a second platform of the collaboration system, the selected compatible action component associated with the second platform.

3. The computer-implemented method of claim 1, further comprising:
in response to each component of the automation rule satisfying a compatibility criteria with each respective adjacent component of the automation rule, enable the service; and
in response to each component of the automation rule not satisfying the compatibility criteria with each respective adjacent component of the automation rule, causing display of a narrative including content related to a potential incompatibility between one or more adjacent components.

4. The computer-implemented method of claim 3, wherein determining the first set of compatible action components for the selected trigger component comprises:
for each action component of the first set of compatible action components, determining whether a user of the collaboration system has permission to perform an action associated with the action component.

5. The computer-implemented method of claim 4, wherein determining whether the user of the collaboration system has permission to perform the action comprises:
determining whether the user has permission to access a platform of the collaboration system that is associated with the action; and
causing display of the action component in response to determining that the user has permission to access the platform.

6. The computer-implemented method of claim 3, further comprising:
determining whether a user of the collaboration system has permission to access a content item of the collaboration system that is referenced by the action; and
causing display of the action component in response to determining that the user has permission to access the content item.

7. The computer-implemented method of claim 1, further comprising:
performing a validation check on the automation rule, the validation check including verifying that each action component of the automation rule has all required inputs; and
in response to identifying that the validation check has failed for the automation rule, causing generation of a graphical element flagging the automation rule as invalid.

8. The computer-implemented method of claim 7, wherein the third graphical element flagging the automation rule as invalid is caused to be generated in proximity to an invalid action.

9. The computer-implemented method of claim 7, further comprising:
in response to identifying that the validation check has failed for the automation rule, causing generation of one or more natural language strings that suggest a fix for the automation rule.

10. The computer-implemented method of claim 1, further comprising:
in response to receiving the second input of the graphical user interface indicating the selection of the compatible action component from the first set of compatible action components:
causing generation of an input field for receiving a user input to define one or more inputs to the compatible action component, the second graphical element generated at least in part in response to receiving the user input for the compatible action component.

11. The computer-implemented method of claim 1, wherein causing generation of the first set of graphical elements comprises:
arranging the first set of graphical elements in the graphical user interface according to an order that is based at least in part on a ranking of actions of the first set of compatible action components.

12. A collaboration system, comprising:
an interface configured to communicate with at least one client device; and
a centralized automation rule service coupled with the first interface, the centralized automation rule service configured to:
cause generation, via the interface, of a graphical user interface at a client device, the graphical user interface including an input field for receiving user input;
receive a first input of the graphical user interface indicating a selection of a trigger component for an automation rule, the selected trigger component displayed in a proposed automation rule flow;
receive a second input of the graphical user interface indicating a selection of a first action component for the automation rule, the selected first action component displayed in a proposed automation rule flow;
determine a first set of compatible action components for the selected first action component based at least in part on an ordering of the action component within the proposed automation rule flow and a compatibility between the action component and the selected first action component;
cause generation of a first set of graphical elements in the graphical user interface, each graphical element of the first set of graphical elements corresponding to a respective compatible action component of the first set of compatible action components;
receive a third input of the graphical user interface indicating a selection of a particular compatible action component from the first set of compatible action components, the selected compatible action component displayed in the proposed automation rule flow with the selected trigger component and the selected first action component;
save an automation rule that includes at least the selected trigger component, the selected first action component, the selected compatible action component, and an object identifier; and
generate a service on the collaboration system that performs an operation in response to an event satisfying the selected trigger component, wherein the operation corresponds to the action component, and the operation is performed on a set of objects selected using the object identifier.

13. The collaboration platform of claim 12, wherein the centralized automation rule service is further configured to:
perform a validation check on the automation rule, the validation check including verifying that each action component of the automation rule has all required inputs; and
enable the service based at least in part on determining that the validation check is successful.

14. The collaboration platform of claim 12, wherein the centralized automation rule service is further configured to:
for each action component of the first set of compatible action components, determine whether a user of the collaboration system has permission to perform an action associated with the action component.

15. The collaboration platform of claim 12, wherein the centralized automation rule service is further configured to:
in response to receiving the second input of the graphical user interface indicating the selection of the compatible action component from the first set of compatible action components:
cause generation of an input field for receiving a user input to define an input to the compatible action component, the second graphical element generated at least in part in response to receiving the input to the input field for the compatible action component.

16. A computer-implemented method for automation rule creation within a collaboration system, the method comprising:
causing generation of a graphical user interface of the collaboration system, the graphical user interface including an input field for receiving user input;
in response to receiving a first input of the graphical user interface indicating a selection of a trigger component for an automation rule:
causing display of a first graphical element representing the selected trigger component in a proposed automation rule flow in in the graphical user interface;
determining a first set of compatible action components for the selected trigger component; and
causing display of a first set of graphical elements in the proposed automation rule flow, each graphical element of the first set of graphical elements corresponding to a respective compatible action component of the first set of compatible action components;
in response to receiving a second input of the graphical user interface indicating a selection of a particular compatible action component from the first set of compatible action components, causing display of a second graphical element representing the selected compatible action component in the proposed automation rule flow;
receiving a third input of the graphical user interface indicating for the collaboration system to save an automation rule that includes at least the selected trigger component, the selected compatible action component, and an object identifier; and
in response to receiving the third input, generating a service on the collaboration system that performs an operation in response to an event satisfying the selected trigger component, wherein the operation corresponds to the action component, and the operation is performed on a set of objects selected using the object identifier.

17. The computer-implemented method of claim 16, further comprising:
in response to receiving the second input indicating the selection of the compatible action component from the first set of compatible action components:
causing generation of an input field for receiving a user input to define one or more inputs to the compatible action component, the second graphical element generated at least in part in response to receiving the user input for the compatible action component.

18. The computer-implemented method of claim 17, further comprising:
in response to one or more characters entered in the input field for receiving the user input for the compatible action component:
determining a set of one or more potential values consistent with the one or more characters entered in the input field; and
causing generation of a selectable list based on the set of one or more potential values, wherein the user input to the input field comprises a selection of a value of the selectable list.

19. The computer-implemented method of claim 17, further comprising:
in response to one or more characters entered in the input field for receiving the user input for the compatible action component:
determining a set of one or more potential values consistent with the one or more characters entered in the input field; and
causing generation of a suggestion of at least one potential value of the set of one or more potential values within the input field for the user input, wherein the user input to the input field comprises a selection of the suggestion of the at least one potential value.

20. The computer-implemented method of claim 17, wherein the user input to the input field for the compatible action component comprises a reference configured to cause the collaboration system to:
transmit a call to a generative output engine that includes a prompt that is based at least in part on a content item of the collaboration system;
obtain, from the generative output engine and in response to the prompt, a generative output for inclusion in the input field.
